(19) United States
(12) Patent Application Publication
(10) Pub. No.: US 2024/0221178 A1
(43) Pub. Date: Jul. 4, 2024

(54) SYSTEMS AND METHODS FOR SPORTS TRACKING USING DIFFUSION MODELS

(71) Applicant: STATS LLC, Chicago, IL (US)

(72) Inventors: Harry HUGHES, Brisbane (AU); Michael John HORTON, Wellington (NZ); Felix WEI, Melbourne (AU); Patrick LUCEY, Chicago, IL (US)

(73) Assignee: STATS LLC, Chicago, IL (US)

(21) Appl. No.: 18/421,539

(22) Filed: Jan. 24, 2024

Related U.S. Application Data
(63) Continuation of application No. 18/401,006, filed on Dec. 29, 2023.
(60) Provisional application No. 63/477,932, filed on Dec. 30, 2022.

(51) Int. Cl. G06T 7/20; G06T 7/70; G06V 20/40

(52) U.S. Cl. CPC G06T 7/20; G06T 7/70; G06V 20/44; G06T 2207/30241

(57) ABSTRACT

A method for tracking one or more individuals during a sporting event, the method including: receiving, as an input, a geospatial data of a sporting event; receiving, as an input, labeled event data of the sporting event; performing multi-object tracking of one or more agents of the geospatial data to determine one or more vectors; inputting the labeled event data and one or more vectors into a diffusion model; and determining, using the diffusion model, one or more trajectory sequences for the one or more agents.

### CROSS-REFERENCE TO RELATED APPLICATIONS

This application claims the benefit of U.S. Provisional Patent Application 63/477,932 filed Dec. 30, 2022 the entire contents of which are incorporated herein by reference for all purposes.

### TECHNICAL FIELD

Various aspects of the present disclosure relate generally to machine learning for sports applications, in particular various aspects relate to systems and methods for performing high-fidelity sports tracking based on a transformer based model and a diffusion model.

### BACKGROUND

With the rising popularity of sports, there is an increased desire for accurate granular predictions of what will occur during a sporting event. For example, predicting how the number of passes or shots that a particular soccer player (e.g., Lionel Messi) will have in the given game (e.g., World Cup final), both prior to and during the World Cup final, can be of particular interest to members of the media, broadcast (whether on the primary feed, or a second screen experience), sportsbook, and fantasy/gamification applications. Existing solutions are unable to accurately make such predictions. In particular, existing solutions may be unable to accurately make predictions to the trajectory one or more players in a game. In particular, existing solutions may be unable to accurately predict trajectory due to, for example, long-term occlusions and tracking errors in broadcast footage. Hence, new solutions are needed.

Unless otherwise indicated herein, the materials described in this section are not prior art to the claims in this application and are not admitted to be prior art, or suggestions of the prior art, by inclusion in this section.

### SUMMARY OF INVENTION

In some aspects, the techniques described herein relate to a method for tracking one or more individuals during a sporting event, the method including: receiving, as an input, geospatial data of a sporting event; receiving, as an input, labeled event data based on sports broadcast footage of the sporting event; performing multi-object tracking of one or more agents of the received geospatial data to determine one or more vectors; inputting the labeled event data and one or more vectors into a diffusion model; and determining, using the diffusion model, one or more trajectory sequences for the one or more agents.

In some aspects, the techniques described herein relate to a method, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes sports broadcast footage, in-venue footage, global positioning system (GPS) data, near field communication (NFC) and/or radio-frequency identification data (RFID).

In some aspects, the techniques described herein relate to a method, wherein the one or more vector includes at least one of an agent two dimensional coordinates on a sporting event's field, an agent position, an agent team, an indicator indicating the agent is a ball, or player visibility information.

In some aspects, the techniques described herein relate to a method, wherein the event data is represented as a two dimensional spatiotemporal grid, the grid representing a stacking of each player's events.

In some aspects, the techniques described herein relate to a method, wherein the diffusion model applies spatiotemporal axial attention on the received event data and one or more vectors, where self-attention is applied across temporal and spatial axis, separately.

In some aspects, the techniques described herein relate to a method, wherein the diffusion model includes: an event encoder; and a tracking decoder, wherein the event encoder encodes the labeled event data and the tracking decoder conditionally decodes trajectory sets.

In some aspects, the techniques described herein relate to a method, wherein the event encoder embeds the event data, embedding the event data further including: tokenzing the labeled event data using a linear projection; applying sinusoidal positional embeddings to specify temporal occurrences of the event data; processing the event data with stacked encoders; and outputting event embeddings.

In some aspects, the techniques described herein relate to a method, wherein the tracking decoder uses attention to embed and fuse the one or more vectors with the event embeddings.

In some aspects, the techniques described herein relate to a method, further including: a second tracking decoder; and a transpose temporal convolution, the temporal convolution being configured to expand trajectories to their initial temporal dimensionality.

In some aspects, the techniques described herein relate to a system for tracking one or more individuals during a sporting event, the system including: a non-transitory computer readable medium configured to store processor-readable instructions; and a processor operatively connected to the memory, and configured to execute the instructions to perform operations including: receiving, as an input, geospatial data of a sporting event; receiving, as an input, labeled event data based on sports broadcast footage of the sporting event; performing multi-object tracking of one or more agents of the received geospatial data to determine one or more vectors; inputting the labeled event data and one or more vectors into a diffusion model; and determining, using the diffusion model, one or more trajectory sequences for the one or more agents.

In some aspects, the techniques described herein relate to a system, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes sports broadcast footage, in-venue footage, global positioning system (GPS) data, near field communication (NFC) and/or radio-frequency identification data (RFID).

In some aspects, the techniques described herein relate to a system, wherein the one or more vector includes at least one of an agent two dimensional coordinates on a sporting event's field, an agent position, an agent team, an indicator indicating the agent is a ball, or player visibility information.

In some aspects, the techniques described herein relate to a system, wherein the event data is represented as a two dimensional spatiotemporal grid, the grid representing a stacking of each player's events.

In some aspects, the techniques described herein relate to a system, wherein the diffusion model applies spatiotemporal axial attention on the received event data and one or more vectors, where self-attention is applied across temporal and spatial axis, separately.

In some aspects, the techniques described herein relate to a system, wherein the diffusion model includes: an event encoder; and a tracking decoder, wherein the event encoder encodes the labeled event data and the tracking decoder conditionally decodes trajectory sets.

In some aspects, the techniques described herein relate to a system, wherein the event encoder embeds the event data, embedding the event data further including: tokenzing the labeled event data using a linear projection; applying sinusoidal positional embeddings to specify temporal occurrences of the event data; processing the event data with stacked encoders; and outputting event embeddings.

In some aspects, the techniques described herein relate to a system, wherein the tracking decoder uses attention to embed and fuse the one or more vectors with the event embeddings.

In some aspects, the techniques described herein relate to a system, further including: a second tracking decoder; and a transpose temporal convolution, the temporal convolution being configured to expand trajectories to their initial temporal dimensionality.

In some aspects, the techniques described herein relate to a non-transitory computer readable medium configured to store processor-readable instructions for tracking one or more individuals during a sporting event, the instructions perform operations including: receiving, as an input, geospatial data of a sporting event; receiving, as an input, labeled event data based on sports broadcast footage of the sporting event; performing multi-object tracking of one or more agents of the received geospatial data to determine one or more vectors; inputting the labeled event data and one or more vectors into a diffusion model; and determining, using the diffusion model, one or more trajectory sequences for the one or more agents.

In some aspects, the techniques described herein relate to a non-transitory computer readable medium, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes sports broadcast footage, in-venue footage, global positioning system (GPS) data, near field communication (NFC) data and/or radio-frequency identification data (RFID).

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a block diagram of an exemplary tracking and analytics environment, according to one or more embodiments.

FIG. 2 depicts an exemplary block diagram of a system for a transformer network for generating trajectories of players, according to one or more embodiments.

FIG. 3 depicts an exemplary scenario of a reverse diffusion process performed by the system, according to one or more embodiments.

FIG. 4 depicts an exemplary graph of player occlusions during an exemplary game, according to one or more embodiments.

FIG. 5A depicts an exemplary block diagram of a diffusion neural network, according to one or more embodiments.

FIG. 5B depicts an exemplary encoder of a diffusion neural network, according to one or more embodiments.

FIG. 5C depicts another exemplary decoder of a diffusion neural network, according to one or more embodiments.

FIG. 6A depicts a first exemplary visualization of a diffusion neural network's predicted trajectories alongside the network's input data and the ground truth data, according to one or more embodiments.

FIG. 6B depicts a second exemplary visualization of a diffusion neural network's predicted trajectories alongside the network's input data and the ground truth data, according to one or more embodiments.

FIG. 6C depicts a third exemplary visualization of a diffusion neural network's predicted trajectories alongside the network's input data and the ground truth data, according to one or more embodiments.

FIG. 7A and FIG. 7B depicts exemplary occlusions of players from an exemplary basketball game, according to one or more embodiments.

FIG. 7C depicts a legend for FIGS. 7A and 7B.

FIG. 8 depicts an exemplary block diagram of a multi-agent trajectory system, according to one or more embodiments.

FIG. 9 depicts exemplary synthetic masking policies, according to one or more embodiments.

FIG. 10 depicts an exemplary visualization of a diffusion neural network's predicted trajectories for possessions of a basketball game, according to one or more embodiments.

FIG. 11 depicts exemplary results for tracking one or more players using a diffusion neural network, according to one or more embodiments.

FIG. 12 depicts an exemplary flowchart of a method for tracking one or more individuals during a sporting event, according to one or more embodiments.

FIG. 13 depicts a flow diagram for training a machine learning model, in accordance with an aspect.

FIG. 14 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to machine learning for sports applications, in particular various aspects relate to systems and methods for a transformer network for generating trajectories of players.

According to embodiments disclosed herein, a guided diffusion model may receive as input broadcast tracking data and event data for a sporting event. The guided diffusion model may generate high-fidelity tracking data based on the received input data. The diffusion model may include an event encoder and a tracking decoder that may embed and fuse the event and broadcast tracking data received. The output embeddings may be fed to score-based diffusion models to generate trajectories of one or more players in a sporting event.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

While soccer and various aspects relating to soccer (e.g., a predicted trajectory for one or more players during a game) are described in the present aspects as illustrative examples, the present aspects are not limited to such examples. For example, the present aspects can be implemented for other sports or activities, such as football, basketball, baseball, tennis, golf, cricket, rugby, and so forth.

The uniform, complete, and scalable digitization of sports broadcast videos into tracking data (player and ball locations through time) may be considered a landmark challenge within computer vision for sport. Conventional vision-centric systems can partially track players from broadcast footage, however, visual constraints of broadcast footage cause this tracking data to suffer from frequent long-term occlusions and/or from tracking errors. The system and methods described herein address this issue by utilizing a diffusion-based multi-agent trajectory generation model which jointly imputes occluded behaviors and de-noises tracking errors. A multi-agent trajectory generation model may fuse large amounts of event data (e.g., soccer's temporal semantic data stream) with raw broadcast tracking data. The multi-agent trajectory generation model described herein may both generate highly realistic behaviors, and allow the injection of domain-specific constraints via guidance.

With the commercialization and popularity of sports, tracking data (e.g., player and ball locations through time) may facilitate deeper analysis of individual and collective performance. Traditionally, sports tracking data has been captured by multi-camera in-venue tracking systems that continuously monitor the locations of all active players and the ball, generating complete tracking. However, the cost of installing and operating these systems has limited their adoption to only the most high-profile leagues.

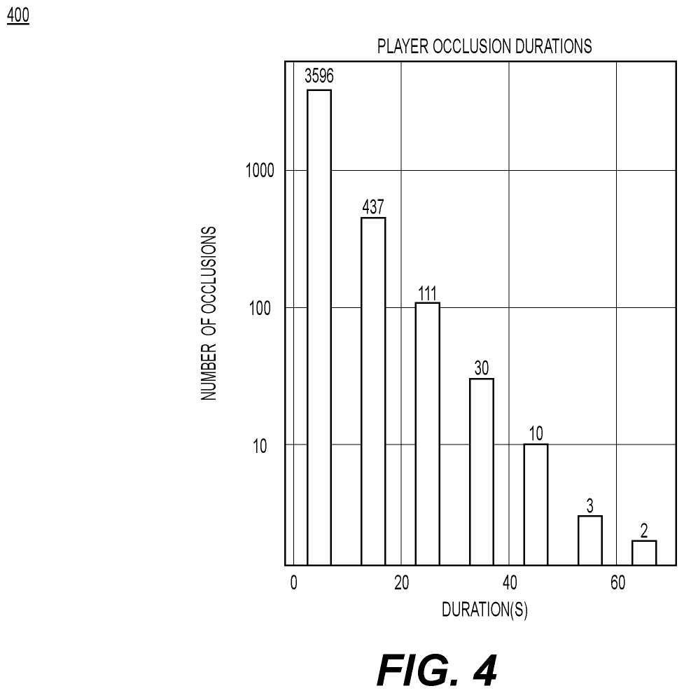

In a sporting event, complete tracking data for all players when an object (e.g., a ball) is in-play may be crucial for tactical analysis of players and teams. Furthermore, given the sparseness of high-leverage events in sporting events (e.g., goal-scoring opportunities), having complete tracking data for each of these events may be essential for down-stream analysis. Conventional broadcast tracking systems may be vision-centric, where the conventional tracking systems may rely predominantly on visual perception. However, with such visual perception, complete tracking data cannot be generated from broadcast footage (e.g., using vision alone). A drawback of conventional vision-centric systems may be caused by the camera's limited receptive field, where important context leading up to a high-probability goal-scoring opportunity may be missed. This example may be representative of the impact that occlusions (e.g., where a subset of agents cannot be visually perceived) have on broadcast tracking systems. Occlusions may have diverse sources, caused by the broadcast camera's limited monocular receptive field, close-ups, replays, and alter-native camera angles. During a sporting event such as soccer, the majority of occlusions may be short-term (≤10 seconds), however, many occlusions last for much longer periods of time, with some occlusions lasting over 60 seconds (e.g., as illustrated in FIG. 4). Additional challenges in conventional systems may be caused by systems having to calibrate to a moving camera, players' homogeneous outfits within teams, and the ball's small size and fast movement, collectively resulting in frequent object detection errors and agent misidentifications in conventional systems. These occlusions and tracking errors degrade both the coverage and quality of raw broadcast tracking, and may need to be addressed to generate accurate and complete remote tracking data.

The systems and techniques described herein may utilize generative modelling to jointly impute and denoise broadcast tracking data. The systems and techniques described herein may be applicable to any sport. For example, the systems and techniques described herein may be applicable to sports with inherently structured game player such as where players adhere to short and long-term policies within the adversarial team-based environment and/or where rigid single and multi-agent spatiotemporal behaviors recur within and across games. The systems and techniques described herein may be configured to learn such structures and multi-agent trajectory generation methods may be used to impute the behaviors of occluded agents and correct erroneous tracking data.

Drawbacks of conventional techniques include a challenge within multi-agent trajectory modelling. First, for example, most trajectory modelling tasks may be completed over independently segmented short-term windows (approximately <10 seconds), where trajectory start and/or end anchors may be observed. This framework may not suitable for broadcast tracking, due to the long duration of soccer matches (e.g., 90+ minutes) and the high frequency of long-term occlusions that exceed approximately 10 seconds. Secondly, for example, rather than performing a forecasting (e.g., predicting future trajectories) or imputation (e.g., generating occluded behaviors), the system described herein may include trajectories that may be jointly forecasted, imputed, and denoised.

The system and techniques described herein may include learning a given sport's coarse and/or long-term latent structure. The system and techniques described herein may include a multimodal foundational architecture. For example, a system or one or more components may be transformer-based, where partially observed multi-agent trajectories (e.g., based on raw broadcast tracking data) are fused with a coarse semantic information stream (e.g., event data). Event data may refer to the sequential stream of all events or all major events throughout a given sports match (e.g., pass, shot, tackle, foul, turnover, penalty, goal, score, substitution, etc.). Event data may provide an essential signal for reconstructing the sections of games that are not covered by raw broadcast tracking data. The system described herein may include joint modelling of event and tracking data. This may represent a paradigm shift away from conventional systems which uni-modally process sporting trajectories. Given the long durations of agent occlusions during the match, a key benefit of the system and techniques described herein may be the large temporal context that the system is able to ingest. For example, the system may adapt the use of spatiotemporal axial attention and temporal convolutions to jointly process tracking data with event context at a time (e.g., three minutes of tracking data with ten minutes of event context).

The system described herein may, for example, incorporate a conditional diffusion model capable of generating multi-agent tracking data. The conditional diffusion model may be configured to learn the conditional probability density function over multi-agent trajectories which may enable the synthesis of highly realistic multi-agent tracking data

The system described herein may be configured to fuse large amounts of tracking and semantic context. By utilizing a diffusion model, realistic trajectories may be generated that inject domain specific constraints via guidance.

To improve upon prior approaches, one or more techniques describe herein utilize a transformer-based neural network to predict player positions. For example, using a transformer-based neural network, the present system can generate or simulate the remainder of a given match at the player trajectory level. For example, the present system may generate players sequences based on an underlying representation of players. A benefit of this approach may be that it can be used as an assistive aid in the data collection process in combination with or side-by-side with tracking systems (e.g., computer vision based player and ball tracking). Such an approach can also be used to highlight a potentially erroneous data point for assessment (e.g., human operators based assessment or automated system based assessment).

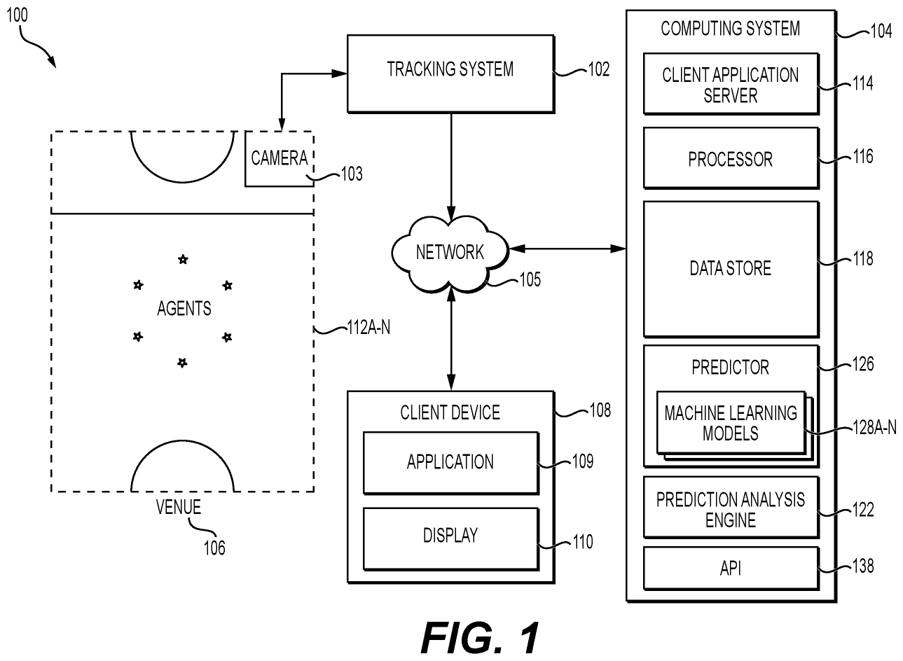

FIG. 1 is a block diagram illustrating a computing environment 100, according to example aspects of the disclosed subject matter. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models. In an example, the one or more machine learning models described herein may be configured to receive as input broadcast tracking data and event data and to perform a conditional guided diffusion to generate trajectories for one or more players in a sporting event.

Tracking system 102 may be in communication with and/or may be positioned in, adjacent to, or near a venue 106. Non-limiting examples of venue 106 include stadiums, fields, pitches, and courts. Venue 106 includes agents 112A-N (players). Tracking system 102 may be configured to record the motions and actions of agents 112A-N on the playing surface, as well as one or more other objects of relevance (e.g., ball, referees, etc.). Although environment 100 depicts agents 112A-N generally as players, it will be understood that in accordance with certain implementations, agents 112A-N may correspond to players, officials, coaches, objects, markers, and/or the like.

In some aspects, tracking system 102 may be an optically-based system using, for example, using camera 103. While one camera is depicted, additional cameras are possible. For example, a system of six stationary, calibrated cameras, which project the three-dimensional locations of players and the ball onto a two-dimensional overhead view of the court may be used.

In another example, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 correspond to or use a broadcast feed of a given match. In such aspects, each frame of the broadcast feed may be stored in a game file.

Tracking system 102 may be configured to communicate with computing system 104 via network 105. Computing system 104 may be configured to manage and analyze the data captured by tracking system 102. Computing system 104 may include a web client application server 114, a pre-processing agent 116 (e.g., a processor and/or preprocessor), a data store 118, and a third-party Application Programming Interface (API) 138. An example of computing system 104 is depicted with respect to FIG. 1500.

Pre-processing agent 116 may be configured to process data retrieved from data store 118 or tracking system 102 prior to input to predictor 126. The pre-processing agent 116, predictor, and/or prediction model analysis engine 122 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store different kinds of data. In an example, data store 118 can store raw tracking data received from tracking system 102. The data store 118 can include historical game data, live data, features, and/or predictions. The historical game data can include historical team and player data for one or more sporting events. Live data can include data received from tracking system 102, e.g., in real time or near real time. Gama data may include broadcast data or content related to a game (e.g., a match, a competition, a round, etc.) and/or may include tracking data generated by tracking system 102 or in response to data generated by tracking system 102. Data store 118 may be configured to store features (e.g., feature vectors) generated for a specific sporting event that incorporate player, team, and match features. Data store 118 may further be configured to store event data for a sporting event.

According to aspects disclosed herein, data store 118 may receive and/or store a game file. A game file may include one or more game data types. A game data type may include, but is not limited to, position data (e.g., player position, object position, etc.) change data (e.g., changes in position, changes in players, changes in objects, etc.), trend data (e.g., player trends, position trends, object trends, team trends, etc.), play data, etc. A game file may be a single game file or may be segmented (e.g., grouped by one or more data type, grouped by one or more players, grouped by one or more teams, etc.). Pre-processing agent 116 and/or data store 118 may be operated (e.g., using applicable code) to receive tracking data in a first format, store game files in a second format, and/or output game data (e.g., to predictor 126) in a third format. For example, pre-processing agent 116 may receive an intended destination for game data (or data stored in data store 118 in general) and may format the data into a format acceptable by the intended destination.

Predictor 126 includes one or more machine-learning models 128A-N. Examples include a transformer neural network that may include one or more encoders and/or decoders. The transformers may be configured to generate tracking data based on broadcast tracking data and on event data. The transformers may be further configured to generate prediction(s) for the trajectory of one or more players during a match. The transformer neural network may be configured to fuse partially observed multi-agent trajectories (e.g., raw broadcast tracking data) with sport based coarse semantic information stream (e.g., event data). The transformer neural network may further include a diffusion model capable of generating multi-agent tracking data. The transformer-based neural network may be configured to generate or simulate the remainder of a given match at the player trajectory level. For example, instead of generating trajectories for a possession, the transformer network may be configured to generate trajectories for multiple possessions and even for the remainder of a sporting event. Further, the transformer network may be further configured to generate event data for the game. In this manner, the transformer network may be used to generate the commentary of a game via text/speech or 3D models of player behaviors.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 (e.g., a GUI) can be displayed on or using display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

### Diffusion-Based Multi-Agent Trajectory Generation Model

The system described herein may utilize transformer based neural network to fuse multi-agent trajectory with sport's semantic even stream data. The system may implement a score-based diffusion framework as described below.

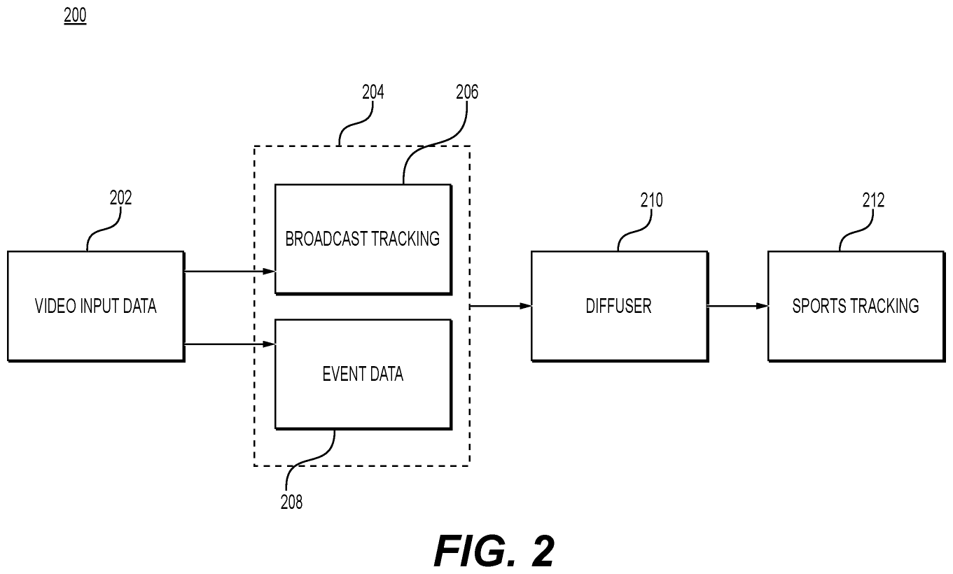

FIG. 2 depicts an exemplary block diagram of a system 200 for a transformer network (e.g., diffuser 210) for generating trajectories of players (e.g., sports tracking information 212), according to one or more embodiments. The system may for example provide conditional guided diffusion (e.g., by diffuser 210) to generate one or more trajectories for a player (e.g., sports tracking information 212) from a limited vision (e.g., from the video input data 202 that includes occlusions).

The system 200 may for example include video input data 202 of a sports broadcast. The video input data 202 may for example have a limited receptive field. For example occlusions may occur where a subset of players cannot be visually displayed on the video input data 202. These occlusions may occur from diverse sources, caused by the broadcast camera's limited monocular receptive field, close-ups, replays, and alter-native camera angles. The video input data (e.g., broadcast data) may for example be a subset of geospatial data. Geospatial data may be any content, information, or feed that may allow tracking of one or more objects, as further discussed herein. For example, geospatial data may refer to broadcast footage, in-venue footage, global satellite positioning (GPS) data, radio-frequency identification data (RDIF), Near Field Communication (NFC), triangulation data, and/or the like. Geospatial data and subsequently processed geospatial data (e.g., by video analysis system 204) may for example be received as input by the diffuser 210 described herein. Video input data may refer to broadcast footage or an in-venue computer vision system output which may be or include, for example, raw video content. An in-venue computer vision system may for example record video footage of an entire field of play throughout and entire match.

The video input data 202 may for example be input into a video analysis system 204. The video analysis system 204 may for example perform one or more functions. First, the video analysis system 204 may implement one or more computer vision algorithms to determine broadcast tracking data 206. The broadcast tracking data 206 may for example be output as multi-agent trajectories for each of the players in a match. The one or more computer vision algorithms may be configured to (1) detect players in a sporting event; (2) classify the detected players into one or more teams; (3) identify a “logical identity” to the identified players in order to maintain identity and track players over a temporal sequence; (4) identify a ground plane of the sporting event; and/or (5) identify the assigned number of each player on the field. The one or more computer vision algorithms may further provide a tracking of identified players over time. The broadcast tracking data 206 may for example be stored in a JavaScript Object Notation (JSON) file. The broadcast tracking data 206 may for example include the two dimensional tracking of one or players in a match, the players respective team, and the player's respective identifying number (e.g., a player's respective jersey number).

The broadcast tracking data 206 may be based on publically available broadcast data and/or footage related to a sports event generated or broadcasted at least in part using one or more cameras or camera systems. Broadcast tracking data 206 may be generated using tracking system 102 of FIG. 1. For example, broadcast tracking data may include a tracking stream determined using computer algorithms applied to a broadcast feed. The tracking stream may represent the movement of an agent (e.g., a player, other individual, object, etc.). The broadcast tracking stream may be represented as b∈R^{T×E×D}^{_{b}}, where each observation contains the agent's 2D coordinate, agent-type (i.e., outfield player, ball, goalkeeper, etc., team affiliation, and indicators as to whether the ball is in-play, and whether the agent is visible.

The second function of the video analysis system 204 may be to determine event data 208. The event data 208 may refer to the sequential stream of all major events throughout the match (e.g., pass, shot, tackle, foul, turnover, penalty, goal, score, substitution, etc.). Event data 208 may provide an essential signal for reconstructing the sections of games that are not covered by raw broadcast tracking data. Event data 208 may for example be automatically detected by a computing system or input from a user reviewing the video input data 202. For example, event data 208 may be input by a user viewing video input data 202 (e.g., a broadcast feed). The event data 208 may be unified to be a two-dimensional spatiotemporal grid. This may be performed by stacking (with padding) each player's events, forming an event stream s∈R^{L×E×D}^{ₛ} where L is the maximum number of events performed by a single agent over a specified time horizon, and each event includes the event's time stamp, 2D coordinates, agent-type, and event category (e.g., pass). Event data 208 may be referred to as “labeled event data” herein.

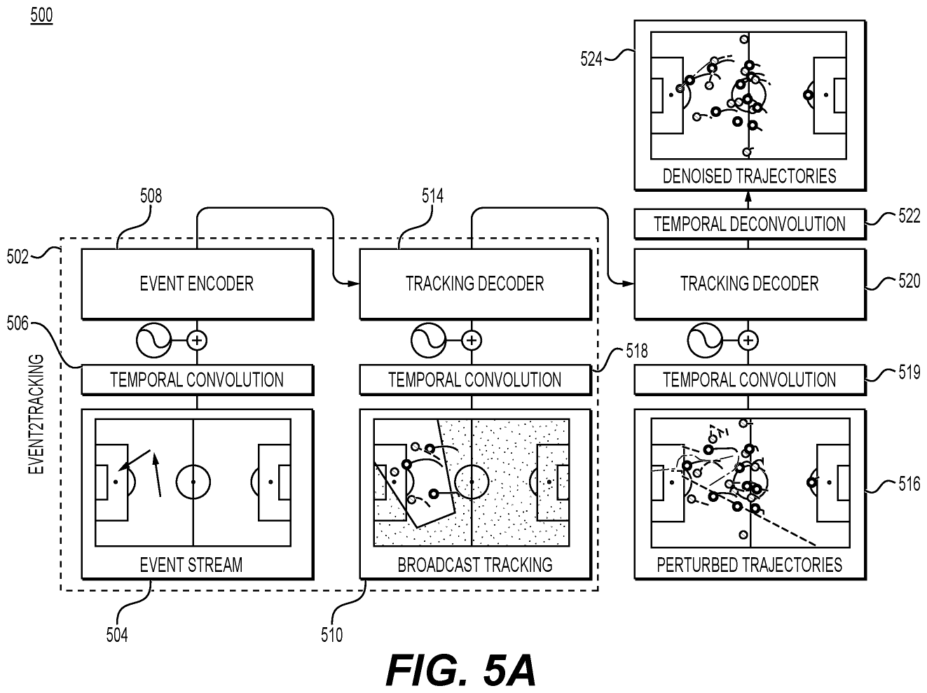

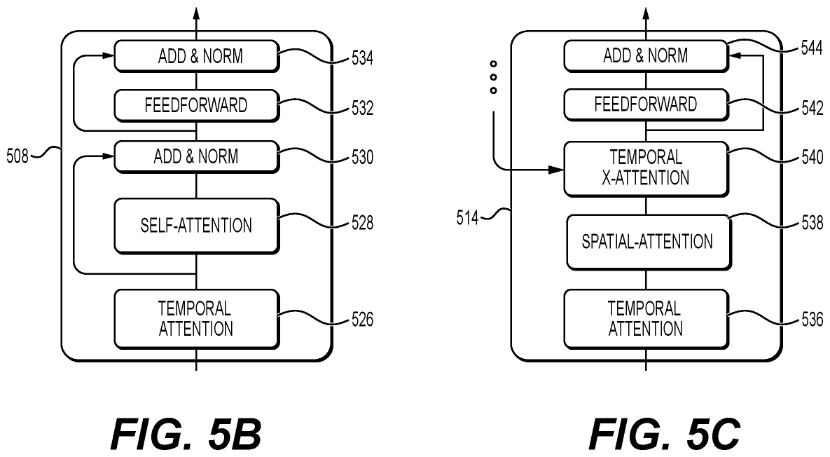

The determined broadcasting tracking data 206 and the event data 208 may for example be input to diffuser 210. Diffuser 210 may for example be depicted by the diffusion neural network 500 of FIG. 5A and described in greater detail below. Diffuser 210 may incorporate a transformer based-neural network. Diffuser 210 may include an encoder (e.g., for operations related at least in part to event data 208) and one or more tracking decoders (e.g., for fusion of the event encoder output and the broadcast tracking data 206), as further discussed herein. The diffuser 210 may generate and output trajectories as sports tracking information 212. These may be output as vectors for further analysis and/or presentation.

As discussed above, processed geospatial data may be received as input by the diffuser 210 (e.g., in place of or in addition to video data 202). For example, the geospatial data may be based on wearable technology worn by the one or more agents on the field. For example, GPS, RFID, and/or NFC data may be received by the system 200. GPS, RFID, and/or NFC data may correspond to location data tracked using GPS sensors, satellite tracking, proximity sensors, tags, and/or the like. Such location data may provide useful context to the system 200 when sensor information (e.g., broadcast data, in-venue sensor information, etc.) is noisy or missing. The geospatial data may also be based on an in-venue computer vision system. The in-venue computer vision data may be utilized to denoise the input (or merge together in the event data 208). The event data 208 may be received in and/or transformed into the frame of reference which is being tracked. For example, the event data may have a frame of reference from (0, 0, 100, 100) whereby the filed coordinate may be (0, 0, 106, 68). Accordingly, the event data may be transformed into the (0, 0, 100, 100) frame of reference using any applicable scaling technique such as a transformation, transfer, normalization, and/or the like.

Further, the diffuser 210 may be configured to receive labelled input such as human labelled inputs (e.g., only event data 208). The system 200 may be configured to impute the position of one or more objects based on event data 208 (e.g., based only one event data 208). Such a labelled input may be received, for example, in text form and may be converted to tracking data based on analysis of the text and/or based on providing the text to a machine learning model trained to output tracking data based on labeled text inputs. In another example, the system may be configured to impute the event data 208 based on one or more inputs discussed herein. For example, the frame on what time interval an event occurred).

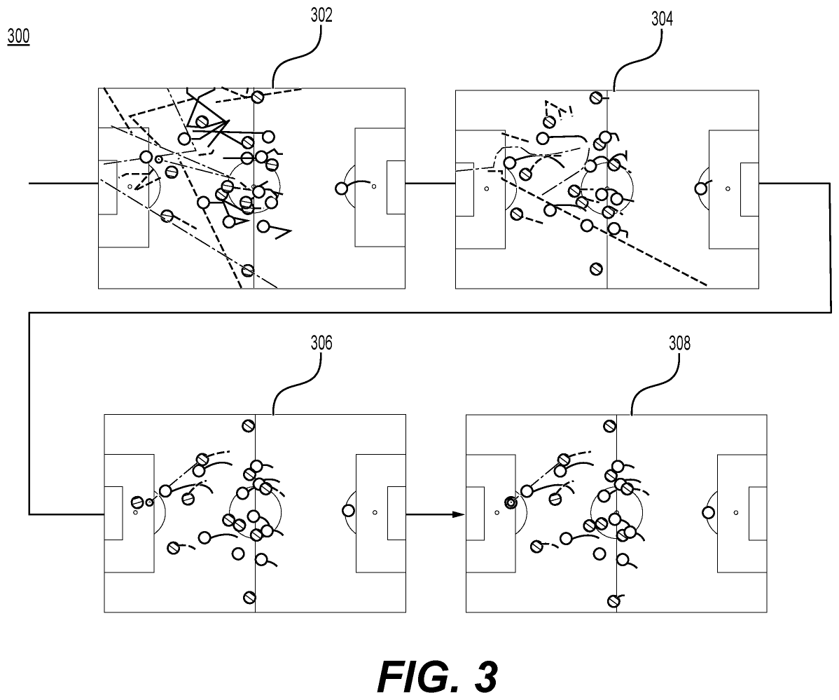

FIG. 3 depicts an exemplary scenario 300 of a reverse diffusion process performed by the system 200, according to one or more embodiments. FIG. 3 depicts the sampling process and how data is denoised. Each image (e.g., image 302, image 304, image 306, image 308) depicts a step of iterative denoising by diffuser 210. FIG. 3 depicts the application of a reverse diffusion process using, for example, diffuser 210, which may be a conditional diffusion model capable of generating multi-agent tracking data. Diffuser 210 may learn a conditional probability density function over multi-agent trajectories, enabling the synthesis of highly realistic multi-agent tracking data. The iterative application of such a function is shown via image 302, image 304, image 306, and image 308, sequentially.

FIG. 4 depicts an exemplary graph 400 of player occlusions during an exemplary game, according to one or more embodiments. Graph 400 depicts the amount of occlusions that occur in an exemplary sporting event's broadcast. Graph 400 depicts how the majority of occlusions of players is short term (e.g., less than 10 second), however, many occlusions last for longer periods of time including periods of time over sixty seconds. The systems and methods described herein determine tracking data for a given event (e.g., including trajectories) based in part on broadcast footage, despite the occlusions as depicted in graph 400.

### Diffuser

Denoising diffusion models may be implemented by the system 200 described herein. Such diffusion models may consider the family of distributions p(x, σ) where Gaussian noise of standard deviation o is added to a data distribution ρ_{data}(x) with standard deviation σ_{data}. Where the Gaussian noise standard deviation may be maximized (i.e., σₘₐₓ), this perturbed data distribution may be virtually indistinguishable from pure Gaussian noise. Samples from this data distribution may thus be generated by iteratively denoising x₀˜N(0, σ²ₘₐₓ|) over range σₘₐₓ, . . . , σ_{N-2}, σ_{N-1} such that xi˜p(xi, σi). Score-based diffusion models may frame this reverse diffusion process as an ordinary differential equation (ODE) where the derivative of the noised sample x is given by:

$$dx = - \dot{σ} ( t ) σ ( t ) ∇ x log p ( x , σ ) , \qquad ( 1 )$$

Where ∇ₓ log p(x, σ) gives the score function, o(t) is the noise level at diffusion step t, and \dot{σ}(t) is the time derivative of o. The score function may be a vector field that gives the direction where the probability density function grows most quickly, from which the underlying probability density function can be inferred. The probability distribution's score function can be obtained by training a conditional de-noising model Dₑ(x, σ, c) parameterized by e to minimize the L2 reconstruction loss between the perturbed and original data sample,

$${E}_{σ \sim q ( σ )} {E}_{x , c \sim {p}_{data}} {E}_{n \sim N ( 0 , {σ}^{2} I )} {‖ {D}_{θ} ( y ; σ , c ) - x ‖}_{2} , \qquad ( 2 )$$

Where q denotes the distribution of o during training and y=x+n. Following this definition, the score is given by:

$${∇}_{y} log p ( y , σ , c ) = ( {D}_{θ} ( y ; σ , c ) - x ) / {σ}^{2} \qquad ( 3 )$$

Training and preconditioning may be implemented for a diffuser model used herein. Such models (e.g., deep models) may learn most effectively when their inputs and outputs are scaled to have unit variance. Furthermore, at low values of o it may be easier to predict the noise level n, whereas at high values of σ it is easier to predict the clean original signal x. Consequently, rather than directly returning the raw output of the denoiser neural network, the diffuser described herein (e.g., diffuser 210) may add preconditioning terms to both scale the variance of the model's inputs, and a skip connection to enable the model to adaptively predict either the noise level or the clean signal for different levels of σ. The denoiser can be written as:

$${D}_{θ} ( y ; σ , c ) = {c}_{skip} ( σ ) y + {c}_{out} ( σ ) {F}_{θ} ( {c}_{input} ( σ ) y ; {c}_{noise} ( σ ) , c ) \qquad ( 4 )$$

Such that F_{θ} is the raw neural network's output, cᵢₙₚᵤₜ modulates the perturbed trajectory's variance, cₙₒᵢₛₑ modulates the noise's variance, Cout modulates the output's variance, and cₛₖᵢₚ modulates the skip connection. To normalize losses over the σ range, the per-sample reconstruction losses are scaled by term λ(σ)=1/c². c may represent a raw input to the neural network, and may be assumed to be modulated.

Constrained sampling may be applied by the diffuser described herein. The diffusion model described herein (e.g., diffuser 210) may learn the conditional score function ∇y log p(y, σ, c) of the probability distribution of multi-agent trajectory sets. However, it is often preferable to sample from the joint score function:

$${∇}_{y} log p ( y , σ , c ) + {∇}_{y} log q ( y , σ , c ) , \qquad ( 5 )$$

Where the second term represents the constraint gradient score for manifold q over y. This constraint manifold may represent any loss function: L:R^{T×E×2}→R that can be differentiated with respect to y. Scaled by hyper parameter a, the constraint gradient score can be calculated as:

$$∇ log q ( y , σ , c ) ) = α \frac{\partial }{\partial y} L ( {D}_{θ} ( y ; σ , c ) ) . \qquad ( 6 )$$

With the ODF dynamics described in equation (1) above, sampling from the diffuser 210 may be performed using, for example, approximately 128 inference steps of the Henu sampler.

In order to prepare (e.g., train) and/or validate diffuser 210, the diffuser 210 is provided access to multiple streams of spatiotemporal data such as video input data 202 (e.g., including broadcast tracking data 206 and/or event data 208) and may be provided in-venue tracking data. Such streams may be represented as spatiotemporal grids which consist of a temporal dimension T specifying the length of trajectories, a spatial dimension (e.g., of size E=23) denoting the number of agents (e.g., two teams of 11 and one ball), followed by a feature dimension. The perturbed in-venue trajectories may be written as y∈R^{T×E×2}, where each observation specifies the agent's perturbed 2D location. Similarly, the broadcast tracking stream is represented as b∈R^{T×E×D}^{_{b}}, where each observation contains the agent's 2D coordinate, agent-type (i.e., outfield player, ball, goalkeeper), team affiliation, and/or indicators as to whether the ball is in-play, and whether the agent is visible. Observations that are not visible may have the agent's 2D coordinate zeroed. While event data may be typically represented as a 1D temporal stream, the event data 208's data stream is represented to be a 2D spatiotemporal grid. This may be achieved by stacking (with padding) each agent's events, forming event stream s∈R^{L×E×D}^{ₛ} where L is the maximum number of events performed by a single agent over a specified time horizon, and each event includes the event's timestamp, 2D coordinates, agent-type, and event category (e.g., pass).

The diffuser 210 may apply spatiotemporal axial attention. The diffuser 210 may process the modalities in a way that maintains their underlying spatiotemporal structure. While spatiotemporal data has a clear temporal total ordering (i.e., chronologically), no such natural ordering may exist over agents spatially. In soccer, because there are two teams each with 10 outfield players with no natural ordering, there may be (10!)² possible permutations of agent indices. To avoid a combinatorial increase in complexity, the spatial dimension of spatiotemporal grids may be processed in a permutation equivariant manner. That is, for example, the following equality may hold for every permutation p of agent indices:

$${F}_{θ} ( y ; σ , c ) = {F}_{θ} ( {y}^{p} ; σ , {c}^{p} ) , ∀ p ∈ [ 1 , {( 10 ! )}^{2} ] , \qquad ( 7 )$$

Where y^{P} and c^{P} may represent permutations of the agent indices for the perturbed in-venue tracking and contextual vectors respectively.

This property may be obtained using spatiotemporal axial attention, where self-attention is applied across temporal and spatial axes separately (e.g., as depicted in FIG. 5A). With this scheme, individual agent motion may be learned through temporal attention, while collective group dynamics can be learned through spatial attention, without imposing an artificial ordering upon agents. Another benefit of axial attention may be its computation efficiency. Standard self-attention may have quadratic performance with respect to sequence length, and therefore jointly attending across spatial and temporal axes has O(T²·E²). Separate axial attention is of O(T²)+O(E²)=O(T²) complexity in cases where sequence length T dominates the number of agents E. This efficiency improvement in the diffuser 210 may allow for the processing of considerably larger length multi-agent trajectories than conventional systems.

FIG. 5A depicts an exemplary block diagram of a diffusion neural network 500, according to one or more embodiments. The diffusion neural network 500 may be an exemplary embodiment of diffuser 210 of FIG. 2.

The diffusion neural network 500 may be configured to embed and fuse the event data (e.g., event data 208) and broadcast tracking context c (e.g., broadcast tracking data 206). The diffusion neural network 500 may include an event encoder 508 as depicted in FIG. 5B and a tracking decoder 514 as depicted in FIG. 5C. Further, the diffusion neural network may include a module 502 that includes the event encoder 508 and the tracking decoder 514. The outputs of the module 502 may be output to score-based diffusion model as described below.

Event data's low temporal dimensionality relative to tracking data may mean that separately encoding these modalities increases the amount of event data able to be encoded at a time. The increased context may improve the accuracy of denoised trajectories.

The diffusion neural network 500 may include an event encoder 508. FIG. 5B depicts an exemplary encoder 508 of a diffusion neural network 500, according to one or more embodiments. The event stream 504 may first have a temporal convolution 506 applied as described above and then be fed to the event encoder 508. The event encoder 508 may include an attention-based architecture which embeds the event stream s∈R^{L×E×D}^{ₛ}. The event stream may first be tokenized using a linear projection, before adding sinusoidal positional embeddings to specify the temporal occurrence of events. Because the event stream consists of each agent's stacked events over a time horizon, positional embeddings may be based on each event's timestep rather than a temporal index. Event tokens may then be processed by stacked event encoders 508, which include a temporal axial attention module 526 that establishes agent ownership over events, followed by a transformer encoder. The transformer encoder may include a self-attention module 528, a first add and norm module 530, a feedforward module 532 and a second add and norm module 534. The self-attention module 528 may perform self-attention related tasks. The self-attention module 528 may not considerably impact the event encoder's computational efficiency, due to the event stream's low temporal dimensionality relative to the tracking streams. The transformer encoder may include a first add and norm module 530 that includes residual connection and layer normalization. The transformer encoder may further include a feedforward module 532, the feedforward module 532 may pass the output through a sequence of linear projections followed by non-linear activation functions. The transformer encoder may include a second add and norm module 534 that includes residual connection and layer normalization. The stacked event encoders produce event embeddings Zₛ∈R^{L×E×d} of dimensionality d. This may be the output of event encoder 508. This output may be forwarded to a tracking decoder 514.

The diffusion neural network 500 may include a tracking decoder 514. FIG. 5C depicts an exemplary decoder 514 of a diffusion neural network 500, according to one or more embodiments. The broadcast tracking data 510 (e.g., broadcast tracking data 206) may first have a temporal convolution 518 applied thereto. The corresponding output, along with the event embeddings out from event encoder 508 may be input into the tracking decoder 514. The tracking decoder 514 may utilize attention to embed and fuse the broadcast tracking stream b∈R^{T×E×D}^{_{b}} with the event embeddings Zs.

The combination of broadcast tracking's high temporal dimensionality and self-attention's quadratic blowup with respect to sequence length may have traditionally limited the length of multi-agent trajectories that can be processed by transformers. This may be addressed by the system described herein, where large amounts of temporal context may be leveraged to denoise long-term occlusions and tracking errors. For example, tracking decoder 514 may compress the broadcast tracking stream b_{conv}∈R^{(T//k)×E×d} by applying temporal convolutions of kernel size and stride k, dimensionality d and 0 padding. By increasing the amount of trajectory context used, the trajectory generations output accuracy may improve.

Following this compression, sinusoidal positional embeddings may be added to specify the temporal ordering of convolved trajectory tokens. Tokens may then be processed with a temporal attention operation 536 followed by spatial attention 538. Next, embedded tokens temporally cross attend with event encodings (e.g., each agent may only attend to its own event tokens). This may occur at a temporal x-attention operation 540. This allows agents to be jointly modelled, avoiding an ego-centric representation as has been completed previously. The final modules within the tracking decoder are the normalization 544 and feedforward layers 542 standard to Transformers. Module 502 (e.g., via tracking decoder 514) may return Z_{b}∈R^{(T//k)×E×d}, which represents joint encodings of each agent's event and broadcast tracking streams. This output may for example be the output of the module 502.

The diffusion neural network 500 may not directly utilize the embeddings output by the module 502 to deterministically predict behaviors of players, but rather may generate trajectories via score-based diffusion models. Score based diffusion models may learn the conditional joint probability distribution over multi-agent trajectory sets, generating much more collectively realistic and controllable behaviors than models trained to independently regress agent locations. Specifically, a trained/activated version of diffuser 210 may represent a denoising diffusion neural network Fₑ(y, σ, c). This network may form the parameterized section of the denoising function shown in Equation (4) and trained with the objective from Equation (2). The perturbed trajectories 516 y∈R^{T×E×2} of FIG. 5A may first be concatenated with, for example, Fourier embeddings of the modulated noise level cₙₒᵢₛₑ(σ), before being compressed temporally using a temporal convolution 519 y_{conv}∈R^{(T//k)×E×d}. As in the module 502 architecture, this may enable processing larger windows of trajectory information. These compressed trajectory tokens may be positionally encoded with sinusoidal positional embeddings. A second tracking decoder 520 may be utilized to fuse the contextual embeddings Z_{b} and tokenized perturbed trajectories y_{conv}. Finally, to expand trajectories to their initial temporal dimensionality, a transpose temporal convolution 522 may be applied. The output of this process may be denoised trajectories 524.

At inference time (e.g., when using a trained diffuser 210 or diffusion neural network 500), the system may adopt constrained trajectory sampling to allow greater control of generated behaviors. The diffusion neural network 500 may utilize this control to enforce physical constraints specific to sport. Events (e.g., event stream 504) may be labelled by any automated system or by humans at 1-second intervals, and as a result, pass events may frequently be out-of-phase with tracking encourages the ball and the player passing the ball to be in close proximity when passes occur. This guidance term aims to reduce the temporal misalignment between event and tracking streams. Formally, Lₚₐₛₛ may be defined as follows,

$${L}_{pass} ( y \hat{} ) = \frac{{\sum }_{t , e ∈ F} ‖ {Y}_{t , e} - {Y}_{t , b} ‖}{{L}_{D} + ϵ} \qquad ( 8 )$$

Where F==[tᵢ, eᵢ]ᵢ₌₀^{L}^{_{D}} includes the timestep t and agent index e of each pass event, b is the ball's spatial index, and ŷ=Dₑ(y; σ, c) is the denoised trajectory, and E is a small constant added to maintain numerical stability.

### Evaluation of Diffusion Neural Network

The diffusion neural network 500 may be evaluated to determine accuracy. To evaluate the coarse and granular realism of generated trajectories, three metrics may be utilized. Coarse behaviors may be evaluated using Average Displacement Error (ADE): the average distance (m) between the generated and real locations of agents. This metric is reported as a total average across all trajectories, for all trajectory segments that are obscured by short-term occlusions (STO) (≤10 seconds) and long-term occlusions (LTO) (>10 seconds). To quantify the granular realism of generated trajectories, two forms of trajectory generation failures may be defined. First, velocity failure rate may be defined as the average proportion of players that exhibit an instantaneous velocity above a threshold of 12 m/s (defined as the maximum human sprinting velocity) over three minute windows. Secondly, a pass failure may reports the percentage of passes that occur outside a 2.5 m radius of the passing player. Only passes where this property is maintained in the in-venue tracking may be considered for the evaluations. These metrics may be averaged across games.

The evaluation may utilize a dataset containing in-venue tracking, broadcast tracking, and event data from, for example, approximately 124 games of professional soccer. In-venue tracking may have been obtained using on-location multi-camera tracking systems, and therefore represents the ground-truth behaviors. Broadcast tracking may have been generated by commercial computer vision tracking systems gathered from publicly accessible broadcast footage. These systems may be made of object detectors, tracklet association algorithms, and camera calibration models. Event data may be provided at scale by human labelling. In reference to an experiment, an evaluation used 109 games for training and 15 games for evaluation. Of the training games, the system had access to broadcast tracking for only 9 games, and for the remaining games, was synthesized broadcast tracking from in-venue tracking. A heuristics-based approach was used to simulate multiple forms of tracking errors (e.g., object detection error, player misidentifications, camera calibration error) and occlusions (e.g., due to the camera's limited receptive field, close-ups, stoppages).

The setting of the system described herein may be vastly different for conventional trajectory modelling settings in terms of the lengths of occlusion, available data streams, and generative objective (i.e., denoising, imputation, and forecasting). Consequently, according to the experiment discussed above, three baselines were devised to evaluate the diffusion neural network 500. First, a Linear Interpolator was used which imputed occluded behaviors by linearly transitioning players from their last to next visible location. Second, a Vanilla Transformer was used which denoised each agent's trajectory independently using the player's broadcast tracking and event streams. Third, a Spatiotemporal Axial Transformer was used. The Spatiotemporal Axial Transformer resembles a Transformer encoder with the multi-headed self-attention implemented as a temporal attention module followed by a spatial attention module. This architecture is able to represent inter-agent dependencies. The Vanilla Transformer and Spatiotemporal Axial Transformer jointly processed 30 seconds of broadcast tracking and event context. These two transformer baselines made no assumptions about trajectory visibility, ingest extended trajectory context, and fuse event data with tracking data, therefore represent much stronger baselines than any previous approaches from conventional systems.

Implementation of the diffusion neural network 500 may include a down sample of the broadcast and in-venue tracking streams to 5 Hz. According to the experiment, the diffuser utilized 180 seconds of trajectory and event context, where each segment also contains 500 seconds of event data before and after the main window. Each attention module of the diffusion neural network 500 used a hidden dimensionality of 128, and a feedforward dimensionality of 512 and 8 attention heads. For module 502, the event encoder 508 and tracking decoder 514 has 2 and 4 layers respectively, and the second tracking decoder 520 has 8 layers. Each tracking decoder uses a temporal convolution (e.g., temporal convolution 518) of stride and kernel-size k=5. Each module 502 may be pre-trained to reconstruct in-venue tracking via a L2 loss objective, before being fine-tuned on the objective (utilizing equation (2) described above).

### Comparison of Diffusion Neural Network:

The quantitative performance of an exemplary use of the diffusion neural network 500 may be compared against the three baselines (linear interpolator, vanilla transformer, and the Spatiotemporal Axial Transformer model) discussed as shown in table 1 below.

TABLE 1
Comparison of diffuser 210 against baselines.

| | | | | | Failure |
|---|---|---|---|---|---|
| | | ADE | (m) | | (%) |
| Method | In-View | STO | LTO | Total | Velocity |
| Linear | 2.33 | 6.01 | 11.78 | 6.69 | 29.68 |
| Vanilla Transformer | 3.01 | 7.16 | 13.53 | 7.78 | 39.88 |
| Axial Transformer | 2.62 | 5.64 | 8.22 | 5.33 | 40.26 |
| Diffuser 210 (ours) | 2.41 | 4.90 | 6.81 | 4.57 | 2.96 |

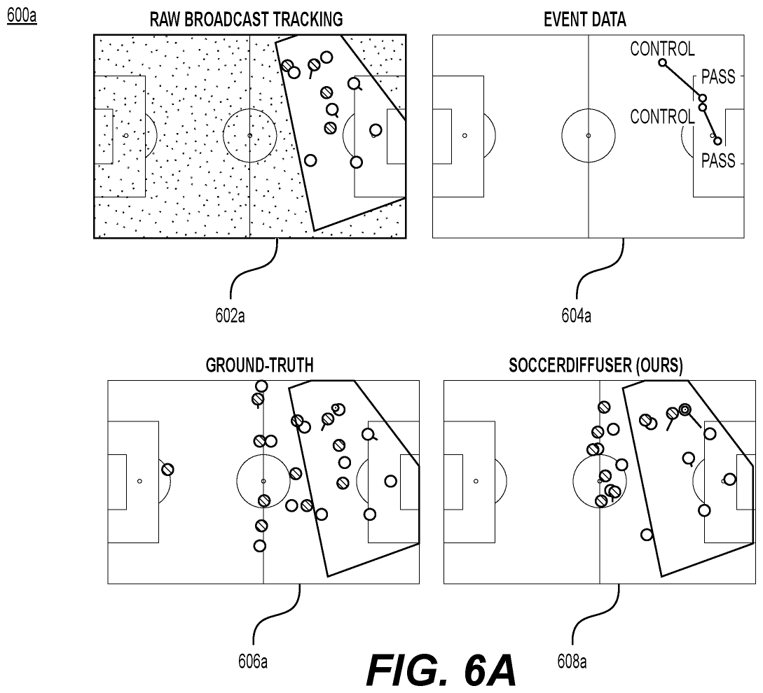

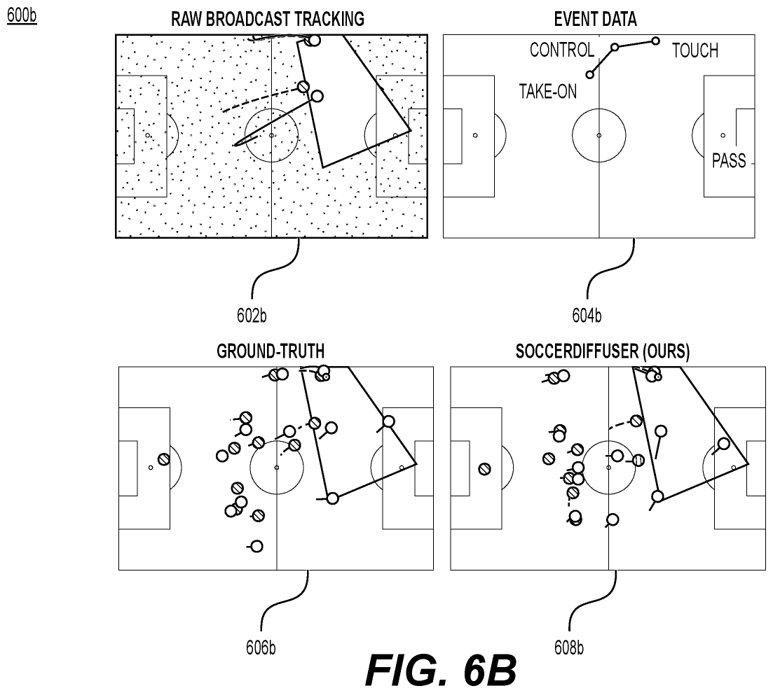

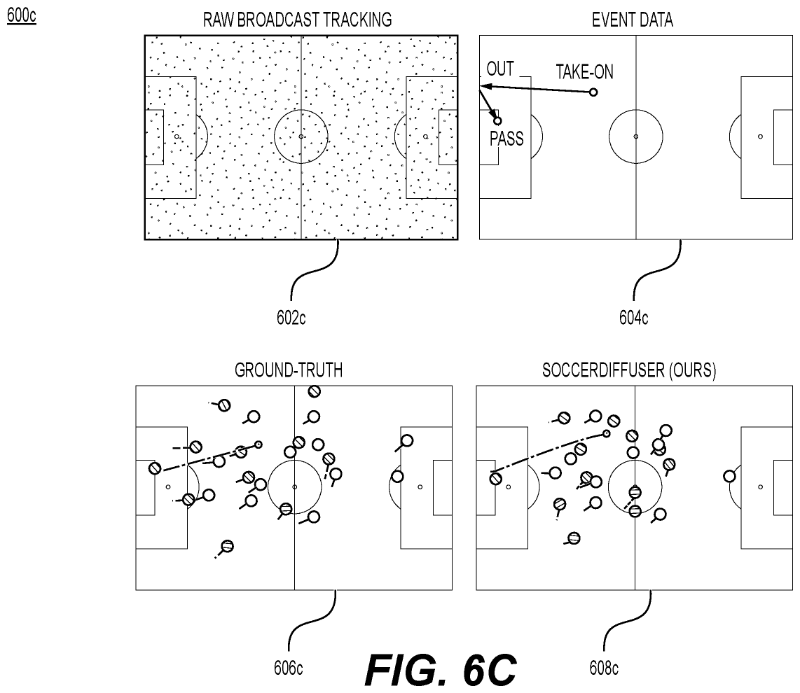

The first two baselines (linear Interpolator and vanilla transformer) may have poor performance in the ADE metrics, as both process each agent's trajectory independently and may not use vital interagent context for denoising and imputing agent behaviors. In contrast, as the Spatiotemporal Axial Transformer models inter-agent dependencies, it may have much stronger performance in terms of reconstructing agent locations. Each baseline however exhibits a high proportion of velocity failures. The Linear Interpolator only imputes missing behaviors, and therefore cannot correct the velocity failures present in broadcast tracking data (e.g., caused by frequent camera calibration errors and misidentifications). While the Vanilla and Spatiotemporal Axial Transformers may be able to denoise the unrealistic behaviors in raw broadcast tracking, they may be limited by their training regime. These models may be trained to minimize L2 reconstruction loss, and although they typically generate locations that are independently reasonable, these locations often do not collectively exhibit realistic human motion. The exemplary use case of the diffusion neural network 500 has both lower ADE metrics and velocity failure rates. The exemplary use case of the diffusion neural network 500 may for example be depicted in FIGS. 6A-6C.

Next, the key components of the diffusion neural network 500 may be ablated to determine their relative impact on the model's performance. The quantitative results for the ablation experiment (ablation study) are depicted in table 2 below:

TABLE 2
Ablation Studies on the diffusion neural
network 500 (e.g., diffuser 210).

| | | | | | Failure |
|---|---|---|---|---|---|
| | | ADE | (m) | | (%) |
| Method | In-View | STO | LTO | Total | Velocity |
| Ours (-diffusion) | 2.58 | 4.85 | 6.42 | 4.48 | 84.89 |
| Ours (-long trajectory) | 3.38 | 6.83 | 10.38 | 6.68 | 5.85 |
| Ours (-expanded | 3.10 | 5.55 | 7.28 | 5.17 | 4.29 |
| event) | | | | | |
| Diffuser 210 (ours) | 2.41 | 4.90 | 6.81 | 4.57 | 2.96 |

The ablation study included ablating diffusion. Examining the ablation, the ablation study first ablated the use of diffusion by directly using outputs of the pre-trained module 502. This model may have strong performance in terms of the average displacement error (ADE) metrics, outperforming the base architecture in terms of reconstructing short term objectives (STOs) and long term objective (LTOs). Primarily, this may be because the Event2Tracking module 502 is trained to directly minimize L2 reconstruction loss. However, as seen in the baseline architectures, training a multi-agent trajectory generative model via reconstruction loss may result in unrealistic collective trajectories as exemplified by the high velocity failure rate

The ablation study included long trajectory context. In this ablation, 30 second trajectory segments may be used instead of 180 seconds, examining the importance of extending the denoising temporal horizon. Shortening the trajectory context may decrease the accuracy of reconstructed locations, as is exhibited by the considerably weaker ADE metrics. This ablation also produced approximately twice as many velocity failures than the base architecture, further reinforcing the importance of utilizing large amounts of trajectory context.

The ablation study included an expanded event. This included matching the event temporal horizon to the 180 second of the trajectory segment. Reducing this context window results in weaker performance in terms of each ADE metric and velocity failure rates. This may further demonstrate the advantage of ingesting as much context as possible when denoising sporting trajectories.

The impact of “pass guidance” on an exemplary use of the diffusion neural network 500 was performed. This was performed by quantitatively comparing the an exemplary use of the diffusion neural network 500 performance both without and with the Pass Guidance sampling as depicted in Table 3.

TABLE 3
Impact of Pass Guidance on diffuser 210 (ours).

| | | ADE | (m) | | Failure | (%) |
|---|---|---|---|---|---|---|
| Method | In-View | STO | LTO | Total | Velocity | Pass |
| Ours (−Pass | 2.41 | 4.91 | 6.85 | 4.58 | 2.14 | 46.64 |
| Guidance) | | | | | | |
| Ours | 2.41 | 4.90 | 6.81 | 4.57 | 2.96 | 5.31 |

While the exemplary use of the diffuser has shown strong performance with respect to the ADE and velocity failure rate metrics, it may have a high pass failure rate. Possible causes of this may include, the pitch's vast size, noisy broadcast tracking, and synchronization issues between the event and tracking streams. However, with Pass Guidance the pass failure rate was considerably decreased, while maintaining strong performance in the other metrics, displaying the granular control that guided diffusion models provide.

FIG. 6A depicts a first exemplary visualization 600a of a diffusion neural network 500's predicted trajectories 608a alongside the network's input data (e.g., the raw broadcast tracking data 602a and the event data 604a) and the ground truth data 606a, according to one or more embodiments.

FIG. 6B depicts a second exemplary visualization 600b of a diffusion neural network 500's predicted trajectories 608b alongside the network's input data (e.g., the raw broadcast tracking data 602b and the event data 604b) and the ground truth data 606b, according to one or more embodiments.

FIG. 6C depicts a third exemplary visualization 600c of a diffusion neural network 500's predicted trajectories 608c alongside the network's input data (e.g., the raw broadcast tracking data 602c and the event data 604c) and the ground truth data 606c, according to one or more embodiments.

The trajectory tails depicted in FIG. 6A-6C may visualize, for example, the prior two seconds of motion. The event data 604a, 604b, 604c displays the sequence of the three previous events that occurred in the scenarios. In the FIG. 6A example, the diffuser neural network may generate highly realistic behaviors for the 12/23 agents who are not visible in the raw broadcast tracking. FIG. 6B depicts the diffuser denoising a camera calibration error in raw broadcast tracking which causes unrealistically rapid motion of the four visible players. FIG. 6C illustrates how even in the sections of games where no raw broadcast tracking is available, the diffuser model may generate realistic and accurate behaviors (e.g., smooth trajectories, player coarse locations being accurate, coarse events are reconstructed in the ball's trajectory).

Accordingly, the diffusion neural network 500 may be capable of producing complete game tracking without in-venue vision systems, representing an important step in providing scalable and uniform game analysis across a given sport. The diffusion neural network 500 may include several key technical components. The module 502's architecture may be a multimodal foundational model. Secondly, the diffusion neural network 500 may integrate a foundational model with guided diffusion, showing that this setup greatly improves the granular realism and controllability of generated behaviors. The diffusion neural network 500 may be configured to apply the module 502 architecture on other game analysis tasks that require both trajectory and semantic perception.

### Masked Autoencoders for Imputing Fine-Grained Adversarial Multi-Agent Trajectories Impaired by Long-Term Occlusions:

Due to the ease of set-up and cost, conventional adversarial multi-agent behaviors are being captured via video (e.g., broadcast video, as described herein). Although valuable, apart from human end-users being able to view the video, the raw pixel information may have little utility for downstream analysis purposes. Compressing raw-pixel information into tracking data (e.g., spatial locations of agents) may provide a compact yet interpretable mid-level representation of agent behaviors. A key problem which may not be solved, using conventional techniques, is how to impute missing tracking segments caused by long-term occlusions. Conventional systems may be unable to impute these forms of long-term occlusions, especially when the starts and ends of analysis streams are unavailable.

The systems and methods described herein may address these limitations with a Multi-Agent Masked Autoencoder (MAT-MAE) system, which may be a robust to diverse forms of multi-agent occlusions. The methods may include imputing long-term occlusions by modelling the distant temporal inter-dependencies that may exist between both trajectory and coarse semantic data-streams. The systems disclosed herein may utilize basketball broadcast tracking data in an exemplary embodiment. The system may outperforms several baselines. An exemplary use of the system may increases the proportion of visible frames in the basketball game by, for example, approximately 26.75% from 59.48% to 86.23%, based on experiments (e.g., such as those described herein).

Video and sensor data of sporting events has grown in recent years allowing for the analysis of fine-grained behaviors in sporting events. This may include behavior analysis of single agents (e.g., motion capture, multiple agents (e.g., autonomous vehicles and human trajectory forecasting), and multiple adversarial agents (e.g., sports and games). An emerging problem within fine-grained multi-agent behavior analysis may be that of trajectory imputation, where multiple agents' movements are reconstructed from partial observations, as discussed herein. This problem may be critical in tracking systems with limited visual perception, which are unable to track agents that are out-of-view (e.g., those based on broadcast tracking). In these cases, trajectory generation techniques may be used to impute occluded appearance information.

Broadcast tracking in sports may forms a valuable test-bed in which the approaches discussed herein can be validated. Unlike traditional in-venue tracking systems which have continual, unimpeded observation of the entire match, broadcast tracking systems may track players directly from broadcast footage. Although this may function well when all players are in-view, broadcast footage contains diverse sources of both partial and full occlusions, as discussed herein.

The methods described herein may partition occlusion into two classes: short-term and long-term occlusion. Short-term occlusion (STO) may occur when a subset of players are out-of-view for a short period of time (e.g., ≤5 seconds). Long-term occlusion (LTO) may refer to the cases where no appearance information is observed for longer periods of time (e.g., >5 seconds), due to advertisements, on-screen graphics, or close-ups of players, coaches, or fans, for example.

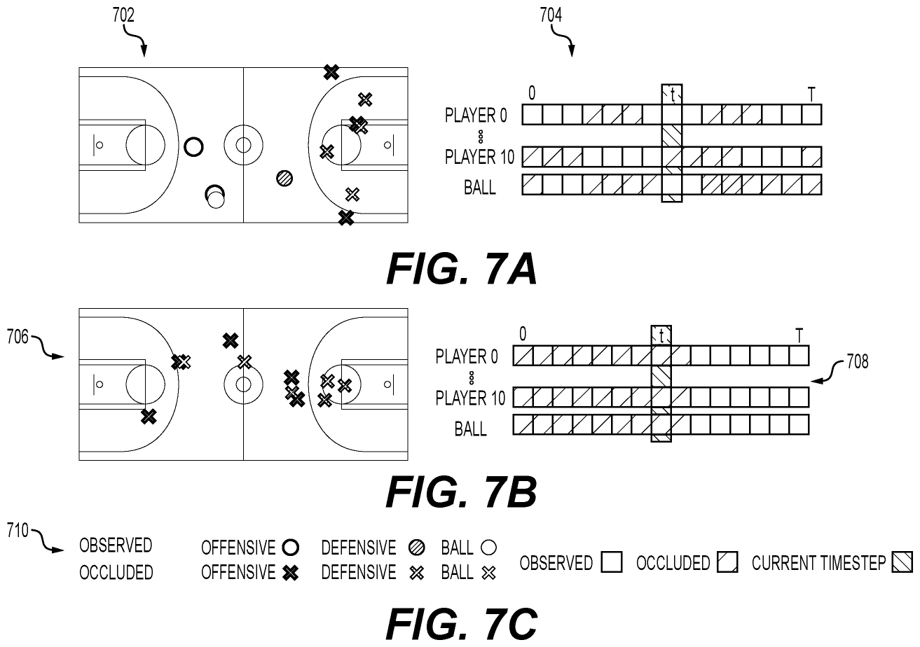

FIG. 7A and FIG. 7B depicts exemplary occlusions of players from an exemplary basketball game, according to one or more embodiments. FIG. 7C depicts a legend 710 for FIGS. 7A and 7B. The legend 710 may depict which players are occluded and/or observed at a particular time. FIG. 7A depicts an example of a STO where a subset of players are unobserved for a short period of time due to a cameras angle as shown in depiction 702. This scenario may be depicted temporally in graph 704. FIG. 7B depicts an example of LTO, where all players locations are occluded (e.g., due to a close-up) as shown in depiction 706. This form of occlusion may be represented temporally in graph 708 where no appearance information is observed for a longer period of time.

Conventional systems that utilize multi-agent trajectories in sports may use the coarse spatial structure that exists within sports to approximate locations of occluded agents. Conventional systems have explored trajectory generation methods to impute occluded appearance information. Exemplary conventional systems may exhibit acceptable performance when imputing STO by fusing bidirectional multi-agent context. However, this approach may be considerably less suited at imputing LTOs. In an exemplary conventional system, a non-autoregressive long-term imputation method may be implemented. This method may not support partial occlusions (e.g., where a subset of players are occluded at a single frame), which occurs frequently in broadcast footage. Finally, conventional approaches both model fixed length trajectories where the starts and ends of trajectories are strictly visible, which may be highly unrealistic assumptions for sport's broadcast tracking data.

Unlike conventional systems which impute behaviors using only trajectory information, sport's semantic data-streams may also be leveraged to more accurately predict behaviors as described herein. One such data-stream is event-detection data, which may specify the timestamps and player identities of the match's on-ball events e.g., pass, rebound, dribble. Semantic information may provide a coarse reconstruction of the game's granular multi-agent behaviors, and may therefore be used to contextualize the large portions of games where trajectory information is fully occluded. As a result, semantic information may substantially increase the capacity to accurately impute LTOs.

The multi-agent trajectory imputation setting may be deeply analogous to the masked modelling framework, where the reconstruction of a partially masked input may be used as a self-supervised pre-training task. Additionally, when fusing sparse semantic information and heavily occluded trajectory data, attention-based models such as transformers may have the beneficial property of being able to model long-term temporal inter-agent dependencies.

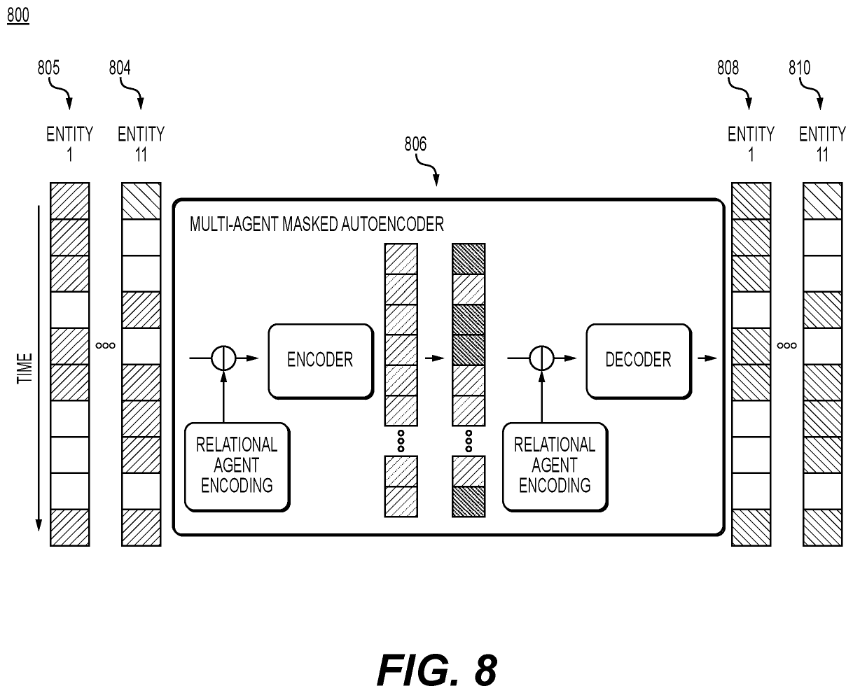

The Multi-Agent Trajectory Masked Autoencoder (MAT-MAE) 806 as depicted in FIG. 8 may address the problems described above. MAT-MAE 806 model may be similar, in certain ways, to the diffusion neural network 500 discussed herein. MAT-MAE 806 may leverage semantic data streams to increase the fidelity of imputed trajectories, especially with LTOs. MAT-MAE 806 may be configured to perform imputation on diverse classes of occlusion, including trajectories where the starts and ends of possessions are heavily occluded. MAT-MAE 806 may include a new application of the Masked Auto encoder (MAE) architecture in the multi-agent behavior generation domain. Using an exemplary single game of heavily occluded basketball broadcasting trading data, MAT-MAE 806 was evaluated as discussed below.

MAT-MAE 806 may be configured to perform long-term trajectory imputation of diverse classes of occlusion. MAT-MAE 806 may produce a trajectory imputation framework that leverages both trajectory streams (e.g., based on broadcast tracking data 206) and semantic data-streams (e.g., based on event data 208). The MAE framework may be adapted to the imputation setting with diverse, unseen forms of LTOs. MAT-MAE 806 may explicitly represents the permutation-invariant relational dynamics of the team-based multi-agent setting.

FIG. 8 depicts an exemplary block diagram of a multi-gent trajectory system 800, according to one or more embodiments. Entity 1 805 and entity 11 804 may include visible and occluded trajectory information respectively over time. An encoder (e.g., encoder 508) may operate on the masked input, and a decoder (e.g., decoder 514) may reconstruct the masked trajectory information. A relational agent encoding method represents the adversarial and cooperative dynamics of team-based environments. MAT-MAE 806 may be configured to output one or more trajectories for the players of a sporting event team (e.g., entity 1 808 and/or entity 11 810).

Multi-agent trajectory imputation may include the task of predicting the occluded locations of agents within a trajectory sequence. Using basketball as an example, all trajectory sets may include K=11 agents (e.g., Agents 112A-N), consisting of five offensive players, five defensive players and a single ball. In addition to partially occluded trajectory information, the system may also leverage the stream of fully visible on-ball player events. Each event includes a timestamp, the player who performed the event, and the event type (including field-goal make, field-goal miss, offensive rebound, defensive re-bound, turnover, pass, inbound pass, block, assist and dribble). Additionally, for certain events supplementary coarse spatial information may be provided. For field-goals, whether the shot was a three-point, mid-range, or close-range attempt may be specified. For inbound passes, the area of the court the pass originated from may be included (i.e., baseline, front-court, backcourt).

The problem addressed by MAT-MAE 806 may be formalized, as further discussed herein. Each possession may be represented as a set of entity trajectories X={Xₖ}ₖ₌₀^{k=1}, where agent k's trajectory consist of T observations Xₖ={Xₖ^{t}}ₖ₌ₜ₌₀^{t-1}. At each timestep t entity k's observations are denoted as xₖ^{t}∈R³, which includes the entity's (x, y) location and their event category i.e., (x, y, event-category). Occlusions may be defined by a mask m∈R^{T×K×3}, where m_{t,k,d}=1 specifies that dimension d of entity k's observation at timestep t is occluded. Within this framework, m_{t,k,2}=0, meaning that player events may be strictly visible. The imputation task may be to use the masked input to generate the trajectory set \hat{X}={\hat{X}ₖ}_{K=0}^{K-1} where entity k's generated trajectory is denoted as \hat{X}ₖ=[\hat{X}ₖ^{t}]_{T=0}^{T-1}[ ]. For inputted trajectories, each prediction \hat{X}ₖ^{t}∈R² specifies the generated (x, y) location of entity k at timestep t. The objective during training may be to minimize the L₂ reconstruction loss of masked trajectory segments i.e., L₂(\hat{X}·m, X·m) where · denotes the Hadamard product.

Multi-agent trajectories may be fundamentally non-Euclidean, as entities have no natural spatial ordering. Consequently, methods which optimally model sets of trajectories may be permutation-invariant. The system may utilize aspects of a permutation-invariant method for pedestrian trajectory prediction, where inter-agent (agent to other agents) and intra-agent (agent to itself) dependencies are modelled separately. However, in adversarial team-based environments, both inter-agent and intra-agent relationships may also dependent on agents' team affiliations. Using basketball as an example, an offensive player's interactions with another agent may depend on whether that agent is another offensive player, a defensive player, or the ball. Furthermore, the manner in which an offensive player attends to themselves may be different to how defensive players attends to themselves. As a result, both agent inter-attention and intra-attention may incorporate team identity.

Consequently, MAT-MAE 806 may include a permutation-invariant agent-based positional encoding method which models the relational dynamics of sport's adversarial environment. To reflect the impact of team identity on inter-agent attention, a separate relative encoding may be computed for each possible ordered pair of team identities. A unique intra-agent relative encoding for each team identity may also be computed. More formally, when attending between agent at index k_{src} with team allegiance a_{src} and agent at index k_{dst} with allegiance a_{dst}.

Relational Agent Encoding γA is computed as,

$$intra - agent = 1 ( {k}_{src} ≡ {k}_{dst} ) \qquad ( 9 )$$

$${γ}_{A} ( {a}_{src} , {a}_{dst} ) = embedding ( ( {a}_{src} , {a}_{dst} , intra - agent ) ) . \qquad ( 10 )$$

Autoencoding may be implemented by MAT-MAE 806. The MAT-MAE 806 may include the ability to represent the long-term inter-agent dependencies that are present in LTOs with sparse semantic information.

Within the MAT-MAE 806 architecture, individual tokens may be represented by an agent k's observations at timestep t. To include the spatiotemporal inductive biases present in multi-agent trajectories, the system may use Shaw's relative positional encodings. Different encoding methods may be employed for both the agent and temporal dimensions of multi-agent trajectories. Temporally, the system may utilize learned positional encodings with a maximum relative attention window relₘₐₓ=±40 frames i.e., ±8 seconds where tracking data is sampled at 5 Hz. These relative temporal encodings γ_{T} between a source time step t_{src} and destination time step t_{dst} may be computed as,

$${t}_{diff} = clip ( {t}_{src} - {t}_{dst} , - {rel}_{max} , {rel}_{max} ) \qquad ( 11 )$$

$${γ}_{T} ( {t}_{src} , {t}_{dst} ) = embedding ( {t}_{diff} ) . \qquad ( 12 )$$

For agent relative positional encoding, the relational agent encoding method described herein is implemented. Consequently, the relative positional encoding γ between xₓ_{_{src}}^{t}^{_{src}} and xₓ_{_{dst}}^{t}^{_{dst}} may be computed as the sum of temporal and agent encodings as:

$$γ ( {x}_{{x}_{src}}^{{t}_{src}} , {x}_{{x}_{dst}}^{{t}_{dst}} ) = {γ}_{T} ( {t}_{src} , {t}_{dst} ) + {γ}_{A} ( {a}_{src} , {a}_{dst} ) . \qquad ( 13 )$$

The MAE may utilize a symmetric autoendoer. The encoder may process both the masked and non-masked tokens, due to the varying number of strictly visible semantic events present in trajectory sequences.

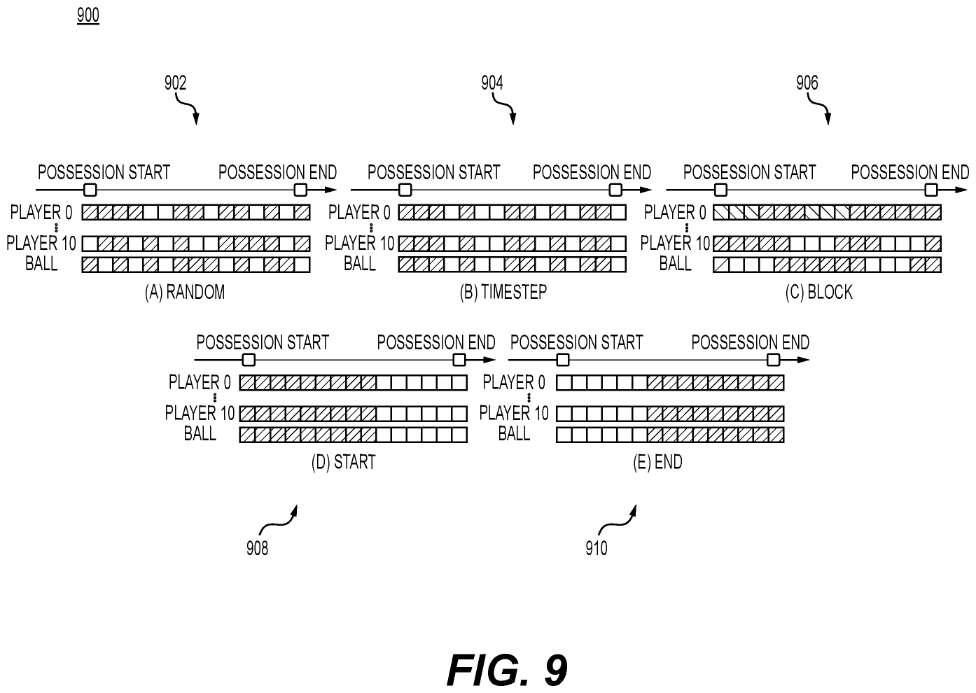

Conventional masked modeling approaches may use imputation as a pre-trained method. These approaches may only investigate the impacts of each policy in isolation. The systems described herein may extend the approaches by using a diverse set of synthetic stochastic masks during training, to enable powerful generalization to a set of unseen, diverse masks. For each batch during training, the system may randomly select from one of the five following policies: random, timestep, block, starts and ends. These masking policies may be depicted in FIG. 9. Furthermore, because the occlusion ratio in the evaluation game was also unseen and variable across trajectories, the system may implement a stochastic masking ratio P which sampled in the range [50%, 95%] for each batch.

FIG. 9 depicts exemplary synthetic masking policies 900, according to one or more embodiments. For example, the masking ratio may be P=60 for visualization. Squares with slashes may represent visible trajectories and unfilled squares represent occluded trajectories. Making policy 902 (a) may depict a Random masking: where P % of tokens are randomly masked. Masking policy 904 (b) may depict a Timestep masking: where P % of timesteps are randomly masked. Masking policy 906 (c) may depict a Block masking: where P % of blocks are randomly masked (blocks of size 3 are used for this visualization). Masking policy 908 (d) may depict a Start making policy: where First P % timesteps are masked. Masking policy 910 (e) may depict an End masking policy: where Final P % timesteps are masked.

Implementation of MAT-MAE 806 may now be described, in reference to an experiment. Accordingly, it will be understood that MAT-MAE 806 may be implemented using techniques, ranges, data, inputs, and outputs similar to, though not the same as that disturbed in reference to the experiment.

For training, a dataset of 100 games of National Basketball Association (NBA) in-venue tracking data have been implemented. The data is down sampled from 25 Hz to 5 Hz, and the games have been separated into possessions. A possessions begin when a team first establishes ownership of the ball in an active play, and conclude when the opposition establish ownership of the ball, or the play becomes in-active (e.g., due to an out-of-bounds). During training, the basketball possessions are partitioned into eight second segments.

MAT-MAE 806 model(s) have been trained for 500 epoch, using a batch-size of 64 and an optimizer with a learning rate of 1e-3 and default exponential decay hyper parameters b₁=0.9 and b₂=0.999. MAT-MAE 806 may be implemented as a symmetrical auto encoder with r-layer transformers, each with a hidden dimensionality of 64 and 4 attention heads. The training may be evaluated on a cluster of GPUs.

The training may be performed on fixed length trajectories of eight second, during evaluation implementation of an autoregressive policy may be performed to impute trajectories of longer length. For example, eight second sliding windows of context may have been implemented where the system autoregressively upgraded four seconds at a time.

MAT-MAE 806 may be validated by performing two experiments each constructing a single game of heavily occluded college basketball tracking data. In the first experiment, the system may be evaluated based on the capacity to reconstruct synthetically masked clean in-venue tracking data, where the synthetic masks represented the occlusions from broadcast footage. This experiment may facilitate a granular evaluation of each method's capacity to impute diverse, realistic forms of occlusions. In the second experiment the system's ability to reconstruct noisy, naturally occluded broadcast tracking data was evaluated. This experiment may reflect a realistic real-world application of trajectory imputation methods, we evaluate reconstructions using macro-level performance analysis metrics from the sporting domain.

During evaluation of the MAT-MAE 806, the imputation method be applied to a single game of college basketball. For this game, both the complete in-venue tracking data and the naturally occluded broadcast tracking data may be processed. The game may be downsampled to 5 Hz, and separated into possessions. In this game, there were a total of 116 possessions. The frequency of each class of occlusion is displayed in Table 5.

TABLE 5
Frequency of occlusion classes in broadcast tracking. For
each class the Occlusion Contribution % is reported, which
specifies the total % of the entire game's frames that
are occluded as a result of each occlusion class.

| | Possessions | Occlusion |
|---|---|---|
| Class of occlusion | Impacted | Contribution % |
| STO | 53 | 12.96 |
| LTO | 41 | 13.79 |
| Full occlusion | 22 | 13.77 |
| No occlusion | 0 | 0 |
| Total | 116 | 40.52 |

To evaluate the fine-grained reconstruction of imputed trajectories, L2 reconstruction loss was computed, which may be the per-possession average distance between the ground-truth and generated locations in occluded sections of trajectories. This metric may be reported separately for each entity and class of occlusion.

The following baselines may have been implemented in the experiment: (i) Linear: this baseline may have completed linear interpolation using visible sections of trajectories. (ii) Bidirectional LSTM: this baseline may have used forwards and backwards LSTM models to separately impute each player's trajectories. (iii) Graph Imputer: this baseline may include a stochastic GNN-based method which uses bidirectional multi-agent context to impute occlusions.

These baselines may not be able to natively complete imputation without trajectory bounds (e.g., the start and end points of trajectories). As a result, the system implemented a lookup-based method which may have imputed the first and final seconds of occluded trajectories. This lookup method may find a similar agent trajectory from the dataset of non-occluded trajectories, and may copy the trajectory's first/final second. Similar trajectories may be defined by both the notable starting event (e.g., baseline inbounds) and/or ending event (e.g., three-point attempt), and the entity's visible trajectory information.

Various ablations studies were conducted for the experiment to investigate the relative contributions of MAT-MAE's 806 architecture's primary components. The first ablation study to the relational agent encoding module. The model was compared to a method which uses absolute positional encoding of agents, randomly indexing agents within each team. The second and third ablations were investigated the autoencoder architecture, utilizing conventional systems. The ablations explored both the impact of using an asymmetrical autoencoder with a shallow 2 layer decoder, and the use of a shallow, symmetrical autoencoder with 2 layer transformers. The ablation further investigated the impact of the synthetic masking policy, using both a random masking policy with a 60% masking ratio and a block mask policy with a block size of 5 and a mask ratio of 60%.

Further Quantitative analysis was performed. Table 6 below depicts the results of various baselines and ablations.

TABLE 6
Quantitative results of in-venue tracking imputation.
All results are reported separately for each type
of entities (denoted as Offensive/Defensive/Ball).

| | Average L2 Reconstruction Loss | |
|---|---|---|
| Method | (ft.) STO LTO | |
| Linear Interpolator | 4.53/4.83/3.50 | 9.50/11.95/6.51 |
| Bidirectional LSTM | 4.36/4.71/3.53 | 8.94/11.26/6.63 |
| Graph Imputer | 4.44/4.76/3.46 | 9.28/11.81/6.36 |
| Ours w/o agent encoding | 2.01/2.65/2.21 | 5.89/6.87/4.64 |
| Ours w/ shallow decoder | 2.13/2.27/2.29 | 5.73/6.92/4.66 |
| Ours w/ shallow autoencoder | 2.15/2.47/1.96 | 5.67/6.80/4.68 |
| Ours w/ random mask | 2.71/2.71/2.06 | 15.14/9.79/21.38 |
| Ours w/ block mask | 1.77/2.01/1.50 | 9.19/8.75/9.07 |
| Ours (MAT-MAE) | 2.02/2.20/2.01 | 5.09/6.95/4.30 |

The system described herein had had average L2 reconstruction losses of 2.02/2.20/2.01 and 5.09/6.95/4.30 for STO and LTO respectively, where losses are reported separately for each class of entities (offensive/defensive/ball). This outperformed each baseline method for each type of entity and class of occlusion.

Experiments were also performed on various ablations of the MAT-MAE 806 architecture. Overall, the base architecture displayed the strongest performance. However, the ablation that exclusively used synthetic block masks for training achieved strong performance for STO imputation, with results of 1.77/2.01/1.50, outperforming the base architecture for each class of entities. However, this ablation displayed considerably weaker performance than the base architecture in reconstructing LTO, highlighting the utility of diverse synthetic masks during training. Although the ablation that applied to MAT-MAE 806 with a shallow autoencoder outperformed the base architecture in reconstructing defenses with LTO, it displayed worse performance than the base architecture in all other metrics.

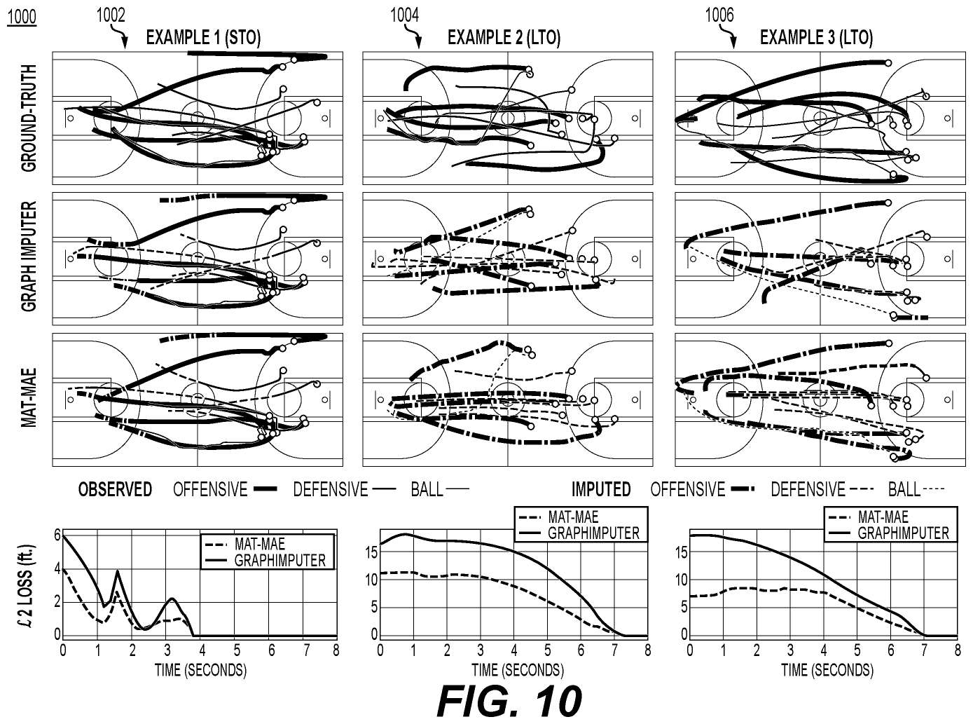

The system of FIG. 8 was further investigated quantitatively. Visualizations of three possessions are provided in FIG. 10.

FIG. 10 depicts an exemplary visualization 1000 of a diffusion neural network's (e.g., MAT-MAE 806) predicted trajectories for possessions of a basketball game, according to one or more embodiments. The visualization 1000 includes a first example 1002 for an STO scenario, a second example 1004 for a LTO scenario, and a third example 1006 for an additional LTO scenario. Each column displays the first eight seconds of each of a different possession segment. The ground-truth, along with the graph imputer and the MAT-MAE 806 predictions for the example scenarios are depicted. The accompanying L2 reconstruction losses for each method is shown temporally for each example.

Qualitatively, based on the experiment depicted in FIG. 10, the MAT-MAE 806 exhibited impressive performance when generating realistic trajectory bounds, especially in the presence of LTOs. This may be exemplified in the second example 1004 and the third example 1006, where agents' initial locations may be generated with no appearance information for the first≥7 seconds of trajectories. In these situations, the MAT-MAE 806 approach is able to realistically impute agent's initial states by fusing the long-term inter-agent dependencies in both trajectory and semantic streams of information. As the baselines chosen cannot natively impute the starts/ends of trajectories, a rule-based method was used to impute these sections of trajectories. Although this rule-based approach only performs marginally worse than the MAT-MAE for STO (as depicted in the first example 1002), its performance degrades considerably for LTO (as depicted in the second example 1004 and third example 1006).

Another notable difference between MAT-MAE's 806 performance and the baselines is that MAT-MAE's method's ability to generate trajectories that demonstrate the semantic actions from the event-detection data-stream. This is evident in the second example 1004 and third example 1006, where in the ground-truth, the ball clearly transitions between two offensive players, representing a pass. This same coarse behavior is represented in the MAT-MAE's output, reflecting its ability to generate multi-agent trajectories that are conditionally dependent on discrete event data. This ability may enabled through MAT-MAE's use of a transformer-based method that is able to perform long-term attention with partially occluded trajectory information and sparse semantic information. In contrast, this distinct behavior is not produced in the graph imputer's output, where instead the ball smoothly transitions from its initial location to its first visible location. At a high-level each of the baselines provide a method for smoothly fusing forwards and backwards context. As a result, these methods may be unable to generate behaviors where an entity's high-level intent changes suddenly in an occluded section of the trajectory, such as in passes.

Regarding the second experiment of MAT-MAE's 806 performance, broadcast tracking imputation was performed. The second experiment reflects the utility of this imputation method in downstream applications. As the system operates in the sports domain, the experiment uses two metrics that are of interest for fitness and performance evaluations: total distance travelled and average speed. These values are also reported across both teams.

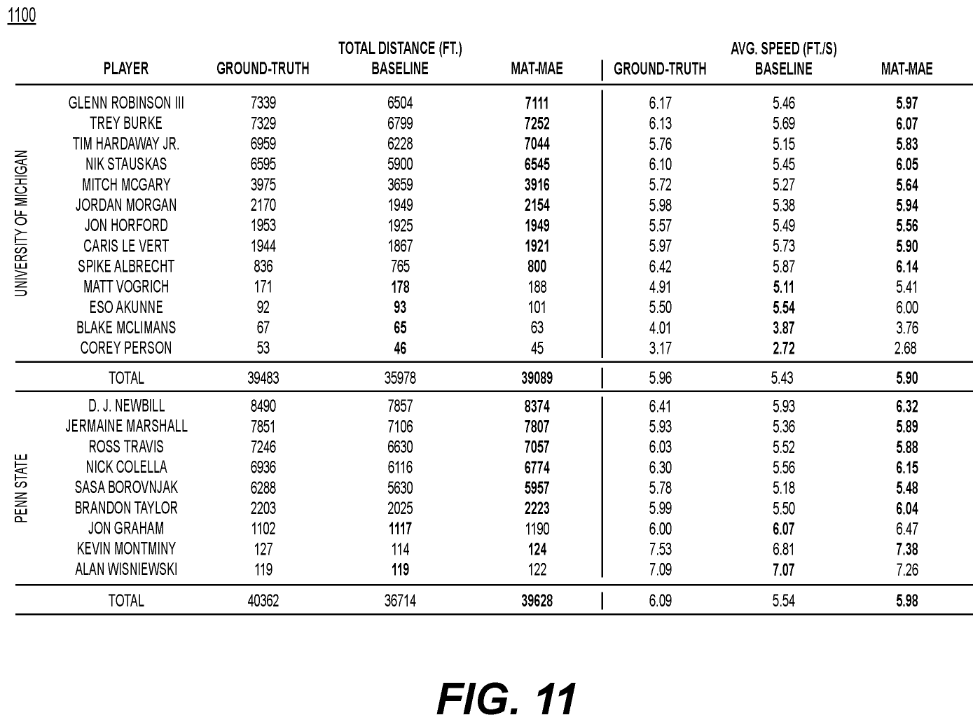

The experiment implements a baseline that predicts player velocities according to entities' average velocities over the visible sections of the game. This average is computed separately for each type of entity (offensive, defensive, ball). FIG. 11 depicts the exemplary results 1100 for tracking of one or more players using the a diffusion neural network (e.g., MAT-MAE 806), according to the experiment described herein.

Examining the results from the experiment, at the team level the MAT-MAE 806 predicted total distance and average speed for the University of Michigan of 39,089 ft. and 5.90 ft./s respectively, and for Penn State of 39,628 ft. and 5.98 ft./s respectively. These metrics were substantially more accurate than the average velocity base-line. Furthermore, at the individual player level, the MAT-MAE 806 was able to more realistically predict total distances for 16 of the total 22 players when compared with the baseline. These strong results reflect the possible downstream performance analysis tasks that without this imputation method would not be feasible.

The MAT-MAE 806 performs multi-agent trajectory imputation. Through leveraging sparse semantic information, the MAT-MAE 806 was able to generate high fidelity behaviors in the presence of diverse forms of LTOs. MAT-MAE 806 demonstrated impressive ability to re-construct semantic events in trajectory space, and to predict agents' realistic initial states when the starts of trajectories were heavily occluded. Both quantitatively and qualitatively the MAT-MAE 806 outperformed a range of baseline imputation methods. Using a single game of naturally occluded basketball broadcast tracking data, the MAT-MAE 806 was able to substantially increase the proportion of fully visible frames by 26.75% from 59.48% to 86.23%. The MAT-MAE 806 had demonstrated utility in downstream domain-specific applications for sport.

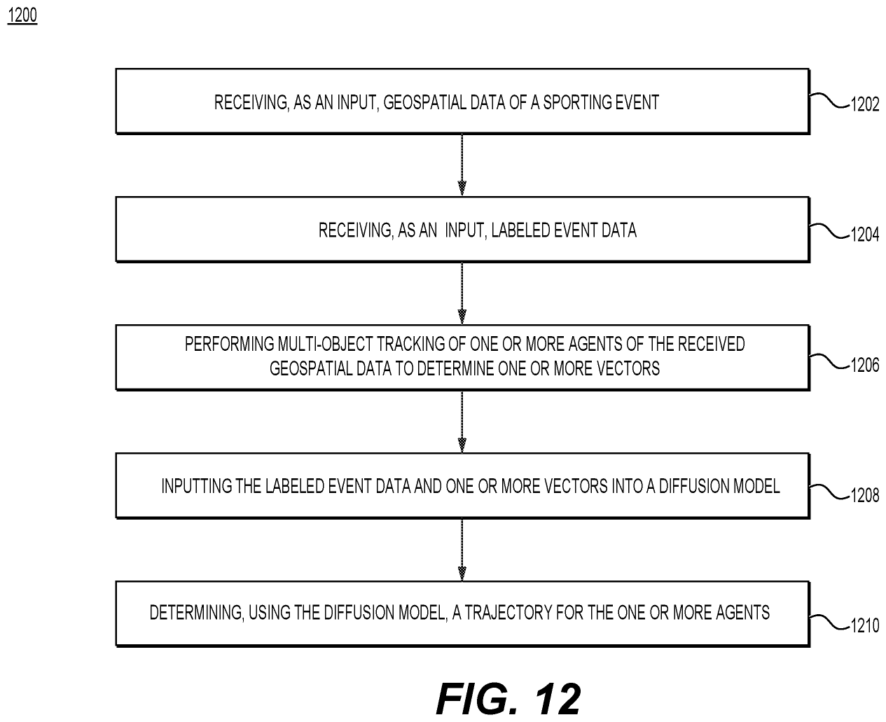

FIG. 12 depicts an exemplary flowchart 1200 of a method for tracking one or more individuals during a sporting event, according to one or more embodiments. The flowchart 1200 may for example be performed by system 200 of FIG. 2. Flowchart 1200 may depict a method for tracking one or more individuals during a sporting event.

At step 1202, a sports broadcast footage of a sporting even may be received as an input.

At step 1204, labeled event data of the sports broadcast footage may be received as an input. The labeled event data may include a sequential stream of one or more major events throughout a sport event, the major events including at least one of a pass, shot, tackle, foul, turnover, penalty, goal, score, or substitution from the sporting event. The event data may be represented as a two dimensional spatiotemporal grid, the grid representing a stacking of each player's events.

At step 1206, multi-object tracking of one or more agents of the received sports broadcast footage may be performed to determine one or more vectors. The one or more vector may include at least one of an agent two dimensional coordinates on a sporting event's field, an agent position, an agent team, an indicator indicating the agent is a ball, or player visibility information.

At step 1208, the labeled event data and one or more vectors may be input into a diffusion model.

At step 1210, one or more trajectory sequences for the one or more agents may be determined using the diffusion model. The diffusion model may apply spatiotemporal axial attention on the received event data and one or more vectors, where self-attention is applied across temporal and spatial axis, separately. The diffusion model may include an event encoder; and a tracking decoder, wherein the event encoder encodes the labeled event data and the tracking decoder conditionally decodes trajectory sets. The event encoder may embed the event data, embedding the event data further including: tokenzing the labeled event data using a linear projection; applying sinusoidal positional embeddings to specify temporal occurrences of the event data; processing the event data with stacked encoders; and outputting event embeddings. The tracking decoder may use attention to embed and fuse the one or more vectors with the event embeddings. The diffusion model may further include a second tracking decoder; and a transpose temporal convolution, the temporal convolution being configured to expand trajectories to their initial temporal dimensionality.

### Neural Network Training and Computing System Overview

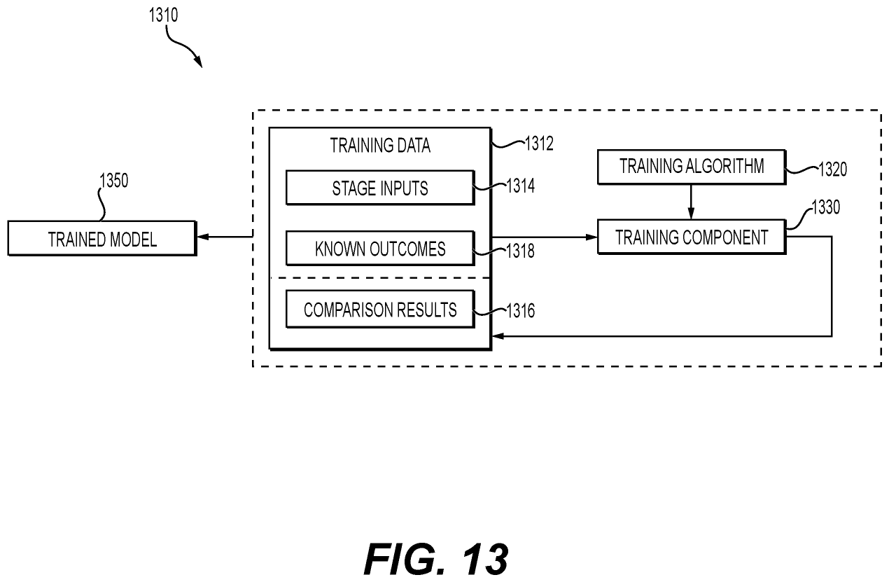

FIG. 13 depicts a flow diagram for training a machine learning model, in accordance with an aspect. As shown in flowchart 1310 of FIG. 13, training data 1312 may include one or more of stage inputs 1314 and known outcomes 1318 related to a machine learning model to be trained. The stage inputs 1314 may be from any applicable source including a component or set shown in the figures provided herein. The known outcomes 1318 may be included for machine learning models generated based on supervised or semi-supervised training. An unsupervised machine learning model might not be trained using known outcomes 1318. Known outcomes 1318 may include known or desired outputs for future inputs similar to or in the same category as stage inputs 1314 that do not have corresponding known outputs.

The training data 1312 and a training algorithm 1320 may be provided to a training component 1330 that may apply the training data 1312 to the training algorithm 1320 to generate a trained machine learning model 1350. According to an implementation, the training component 1330 may be provided comparison results 1316 that compare a previous output of the corresponding machine learning model to apply the previous result to re-train the machine learning model. The comparison results 1316 may be used by the training component 1330 to update the corresponding machine learning model. The training algorithm 1320 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1310 may be a trained machine learning model 1350.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

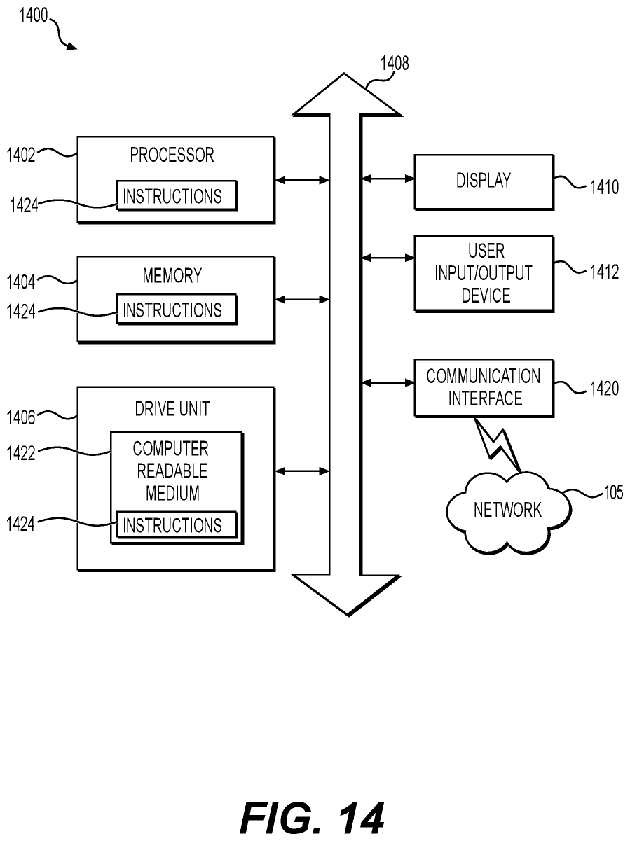

FIG. 14 is a simplified functional block diagram of a computer 1400 that may be configured as a device for executing the methods disclosed here, according to exemplary aspects of the present disclosure. For example, the computer 1400 may be configured as a system according to exemplary aspects of this disclosure. In various aspects, any of the systems herein may be a computer 1400 including, for example, a data communication interface 1420 for packet data communication. The computer 1400 also may include a central processing unit (“CPU”) 1402, in the form of one or more processors, for executing program instructions. The computer 1400 may include an internal communication bus 1408, and a storage unit 1406 (such as ROM, HDD, SDD, etc.) that may store data on a computer readable medium 1422, although the computer 1400 may receive programming and data via network communications.

The computer 1400 may also have a memory 1404 (such as RAM) storing instructions 1424 for executing techniques presented herein, for example the methods described with respect to FIG. 13, although the instructions 1424 may be stored temporarily or permanently within other modules of computer 1400 (e.g., processor 1402 and/or computer readable medium 1422). The computer 1400 also may include input and output ports 1412 and/or a display 1410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed embodiments requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed:

1. A computer implemented method for tracking one or more individuals during a sporting event, the method comprising:
receiving, as an input, geospatial data of a sporting event;
receiving, as an input, labeled event data based on sports broadcast footage of the sporting event;
performing multi-object tracking of one or more agents of the received geospatial data to determine one or more vectors;
inputting the labeled event data and one or more vectors into a diffusion model; and
determining, using the diffusion model, one or more trajectory sequences for the one or more agents.

2. The method of claim 1, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes one or more of the sports broadcast footage, in-venue footage, global positioning system (GPS) data, near field communication (NFC) data, or radio-frequency identification (RFID) data.

3. The method of claim 1, wherein the one or more vector includes at least one of an agent two dimensional coordinates on a sporting event's field, an agent position, an agent team, an indicator indicating the agent is a ball, or player visibility information.

4. The method of claim 1, wherein the event data is represented as a two dimensional spatiotemporal grid, the grid representing a stacking of each player's events.

5. The method of claim 1, wherein the diffusion model applies spatiotemporal axial attention on the received event data and one or more vectors, where self-attention is applied across temporal and spatial axis, separately.

6. The method of claim 1, wherein the diffusion model includes:
an event encoder; and
a tracking decoder,
wherein the event encoder encodes the labeled event data and the tracking decoder conditionally decodes trajectory sets.

7. The method of claim 6, wherein the event encoder embeds the event data, embedding the event data further comprising:
tokenzing the labeled event data using a linear projection;
applying sinusoidal positional embeddings to specify temporal occurrences of the event data;
processing the event data with stacked encoders; and
outputting event embeddings.

8. The method of claim 7, wherein the tracking decoder uses attention to embed and fuse the one or more vectors with the event embeddings.

9. The method of claim 6, further including:
a second tracking decoder; and
a transpose temporal convolution, the temporal convolution being configured to expand trajectories to their initial temporal dimensionality.

10. A system for tracking one or more individuals during a sporting event, the system comprising:
a non-transitory computer readable medium configured to store processor-readable instructions; and
a processor operatively connected to the memory, and configured to execute the instructions to perform operations comprising:
receiving, as an input, geospatial data of a sporting event;
receiving, as an input, labeled event data of based on sports broadcast footage of the sporting event;
performing multi-object tracking of one or more agents of the received geospatial data to determine one or more vectors;
inputting the labeled event data and one or more vectors into a diffusion model; and
determining, using the diffusion model, one or more trajectory sequences for the one or more agents.

11. The system of claim 10, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes one or more of the sports broadcast footage, in-venue footage, global positioning system (GPS) data, near field communication (NFC) data, or radio-frequency identification (RFID) data.

12. The system of claim 10, wherein the one or more vector includes at least one of an agent two dimensional coordinates on a sporting event's field, an agent position, an agent team, an indicator indicating the agent is a ball, or player visibility information.

13. The system of claim 10, wherein the event data is represented as a two dimensional spatiotemporal grid, the grid representing a stacking of each player's events.

14. The system of claim 10, wherein the diffusion model applies spatiotemporal axial attention on the received event data and one or more vectors, where self-attention is applied across temporal and spatial axis, separately.

15. The system of claim 10, wherein the diffusion model includes:
an event encoder; and
a tracking decoder,
wherein the event encoder encodes the labeled event data and the tracking decoder conditionally decodes trajectory sets.

16. The system of claim 15, wherein the event encoder embeds the event data, embedding the event data further comprising:
tokenzing the labeled event data using a linear projection;
applying sinusoidal positional embeddings to specify temporal occurrences of the event data;
processing the event data with stacked encoders; and
outputting event embeddings.

17. The system of claim 16, wherein the tracking decoder uses attention to embed and fuse the one or more vectors with the event embeddings.

18. The system of claim 15, further including:
a second tracking decoder; and
a transpose temporal convolution, the temporal convolution being configured to expand trajectories to their initial temporal dimensionality.

19. A non-transitory computer readable medium configured to store processor-readable instructions, wherein when executed by a processor, the instructions perform operations comprising:
receiving, as an input, geospatial data of a sporting event;
receiving, as an input, labeled event data based on sports broadcast footage of the sporting event;
performing multi-object tracking of one or more agents of the geospatial data to determine one or more vectors;
inputting the labeled event data and one or more vectors into a diffusion model; and
determining, using the diffusion model, one or more trajectory sequences for the one or more agents.

20. The non-transitory computer readable medium of claim 19, wherein the labeled event data includes a sequential stream of one or more major events throughout a sport event, the major events including at least one of a pass, shot, tackle, foul, turnover, penalty, goal, score, or substitution from the sporting event, and wherein the geospatial data includes one or more of the sports broadcast footage, in-venue footage, global positioning system (GPS) data, near field communication (NFC) data, or radio-frequency identification (RFID) data.
